(19) United States
(12) Patent Application Publication
(10) Pub. No.: US 2026/0342939 A1
(43) Pub. Date: Oct. 29, 2026

(54) DISPLAY DEVICE AND DEVICE CONTROL METHOD

(71) Applicant: HISENSE VISUAL TECHNOLOGY CO., LTD., Qingdao (CN)

(72) Inventors: Hao WANG, Qingdao (CN); Jianliang WANG, Qingdao (CN); Yinghao HE, Qingdao (CN); Yi ZHANG, Qingdao (CN)

(21) Appl. No.: 19/705,292

(22) Filed: Jun. 11, 2026

Related U.S. Application Data
(63) Continuation-in-part of application No. PCT/CN2024/121220, filed on Sep. 25, 2024.

(30) Foreign Application Priority Data
Dec. 12, 2023 (CN) 202311704162.9
Dec. 12, 2023 (CN) 202311705265.7
Dec. 21, 2023 (CN) 202311771270.8

(51) Int. Cl. H04N 7/10; G06F 3/16; H04N 21/4363; H04N 21/442

(52) U.S. Cl. CPC H04N 7/104; H04N 21/43635; H04N 21/44227; G06F 3/162

(57) ABSTRACT

A display device and a device control method are provided in the present disclosure. The method includes: when a CEC device accesses a display device by means of an HDMI expansion interface, sending an SCDC interaction trigger signal to the CEC device by means of a receiving pin of a first switching circuit; identifying a first interface number of the HDMI expansion interface, which is accessed by the CEC device, and sending the first interface number to a second switching circuit; and the second switching circuit switching a communication link to the HDMI expansion interface corresponding to the first interface number, and the display device being capable of performing SCDC interaction with the CEC device on the basis of the communication link.

### CROSS REFERENCE TO RELATED APPLICATION

This disclosure is a continuation-in-part of International Application No. PCT/CN2024/121220, filed on Sep. 25, 2024, which claims the priorities to the Chinese applications No. 202311704162.9 filed on Dec. 12, 2023, No. 202311705265.7 filed on Dec. 12, 2023 and No. 202311771270.8 filed on Dec. 21, 2023, of which the entire contents are incorporated herein by reference.

### TECHNICAL FIELD

The present disclosure relates to the technical field of display devices, and in particular to a display device and a device control method.

### BACKGROUND

High definition multimedia interface (HDMI) is a special digital interface suitable for image transmission, which can simultaneously transmit audio signals and image signals. Currently, HDMI has been standardized, and consumer electronics control (CEC) is a complete single bus protocol generated by HDMI standardization. Display devices can use CEC signals to control external devices connected to HDMI interfaces. The controlled external devices are called CEC devices.

After the CEC device inputs the HDMI signal to the display device, if the display device supports the status and control data channel (SCDC) function, the CEC device will interact with the display device through SCDC. According to the value generated during the SCDC interaction process, it can be determined whether the interaction between the display device and the CEC device is normal. In actual applications, the CEC device can use the switching circuit (Switch) to expand the native HDMI interface into multiple channels. At this time, the SCDC interaction between the display device and the CEC device needs to go through two levels of SCDC interaction in the switching circuit (including the transmitting pin SwitchRX and the receiving pin SwitchTX), which will result in a relatively long SCDC interaction time, thereby affecting the user experience.

### SUMMARY

In a first aspect, embodiments of the present disclosure provide a display device, including: a display; at least two HDMI extension interfaces, wherein the HDMI extension interface is communicatively connected to an HDMI native interface via a switching circuit; the switching circuit includes a first switching circuit and a second switching circuit; the first switching circuit includes a transmitting pin and a receiving pin, wherein the receiving pin is configured to send a status and control data channel (SCDC) interaction trigger signal to a consumer electronics control (CEC) device when the CEC device is connected to the display device via the HDMI extension interface; the second switching circuit does not include the transmitting pin and the receiving pin; at least one processor, connected to the display, the HDMI extension interface, the HDMI native interface and the switching circuit, and configured to execute computer instructions to enable the display device to: in response to the CEC device being connected to the display device via the HDMI extension interface, identify a first interface number of the HDMI extension interface connected to the CEC device, and receive SCDC interaction information fed back by the CEC device, wherein the SCDC interaction information is the information fed back by the CEC device according to an SCDC interaction trigger signal; send the first interface number to the second switching circuit, to switch a communication link between the at least one processor and the HDMI extension interface corresponding to the first interface number; in response to the CEC device determining that the display device supports an SCDC function based on the SCDC interaction information, perform SCDC interaction with the CEC device based on the communication link directly connected.

In a second aspect, embodiments of the present disclosure further provide a device control method, including: in response to a CEC device being connected to a display device via an HDMI extension interface, identifying a first interface number of the HDMI extension interface connected to the CEC device, and receiving SCDC interaction information fed back by the CEC device, wherein the display device includes at least two HDMI extension interfaces, and the HDMI extension interface is in communication with an HDMI native interface via a switching circuit; the switching circuit includes a first switching circuit and a second switching circuit; the first switching circuit includes a transmitting pin and a receiving pin, and the receiving pin is configured to send an SCDC interaction trigger signal to the CEC device in response to the CEC device being connected to the display device via the HDMI extension interface; the second switching circuit does not include the transmitting pin and the receiving pin; the SCDC interaction information is information fed back by the CEC device according to the SCDC interaction trigger signal; sending the first interface number to the second switching circuit, to switch a communication link between at least one processor of the display device and the HDMI extension interface corresponding to the first interface number via the second switching circuit; in response to the CEC device determining that the display device supports an SCDC function based on the SCDC interaction information, performing SCDC interaction with the CEC device based on the communication link directly connected.

### BRIEF DESCRIPTION OF FIGURES

FIG. 1 is a schematic diagram of an operation scenario between a display device and a control device according to some embodiments.

FIG. 2 is a block diagram of a hardware configuration of a control device according to some embodiments.

FIG. 3 is a block diagram of a hardware configuration of a display device according to some embodiments.

FIG. 4 is a block diagram of a software configuration of a display device according to some embodiments.

FIG. 5 is a hardware circuit diagram of an SOC including only a native HDMI interface according to some embodiments.

FIG. 6 is a hardware circuit diagram of an SOC including an HDMI native interface and an HDMI extension interface according to some embodiments.

FIG. 7 is a hardware circuit diagram of an SOC including a switching circuit according to some embodiments.

FIG. 8 is a hardware connection block diagram of some functional modules of a display device according to some embodiments.

FIG. 9 is a hardware circuit diagram of another SOC including a switching circuit according to some embodiments.

FIG. 10 is a flow chart of a method for a display device to interact with a CEC device according to some embodiments.

FIG. 11 is a flow chart of sending an SCDC interaction trigger signal through a first switching circuit according to some embodiments.

FIG. 12 is a flowchart of interaction between a display device and a CEC device according to some embodiments.

FIG. 13 is a flow chart of logical address allocation for CEC devices according to some embodiments.

FIG. 14 is a flow chart of identifying a first interface number according to some embodiments.

FIG. 15 is a schematic diagram of EDID file transmission principles according to some embodiments.

FIG. 16 is a flow chart of performing SCDC interaction through a first switching circuit according to some embodiments.

FIG. 17 is a flow chart of performing SCDC interaction through a second switching circuit according to some embodiments.

FIG. 18 is another flow chart of sending an SCDC interaction trigger signal through a first switching circuit according to some embodiments.

FIG. 19 is a schematic diagram of a user interface according to some embodiments.

FIG. 20 is a schematic diagram of an application panel according to some embodiments.

FIG. 21 is a schematic diagram of connecting a display device and an external device according to some embodiments.

FIG. 22 is a schematic diagram of confirmation information of a media resource signal abnormal state repair mode according to some embodiments.

FIG. 23 is a flow chart of various components in a display device repairing an abnormal state of a media resource signal according to some embodiments.

FIG. 24 is a diagram of a 256-byte EDID and a 512-byte EDID according to some embodiments.

FIG. 25 is a schematic diagram of frame data of an information frame according to some embodiments.

FIG. 26 is a schematic diagram of a data block type corresponding to each byte bit of PB3 according to some embodiments.

FIG. 27 is a schematic diagram of first prompt information according to some embodiments.

FIG. 28 is a schematic diagram of second prompt information according to some embodiments.

FIG. 29 is a schematic diagram of a signal source interface according to some embodiments.

FIG. 30 is a flow chart showing the process of executing video playback by various components in a display device according to some embodiments.

FIG. 31 is a schematic diagram of hardware connection between a power amplifier device and a display device according to some embodiments.

FIG. 32 is a schematic diagram of a display showing first prompt information according to some embodiments.

FIG. 33 is a schematic diagram showing the connection between a media resource device, a power amplifier device and a display device according to some embodiments.

FIG. 34 is a schematic diagram showing the connection between a media resource device, a power amplifier device and a display device according to some embodiments.

FIG. 35 is a video playback channel setting interface according to some embodiments.

### DETAILED DESCRIPTION

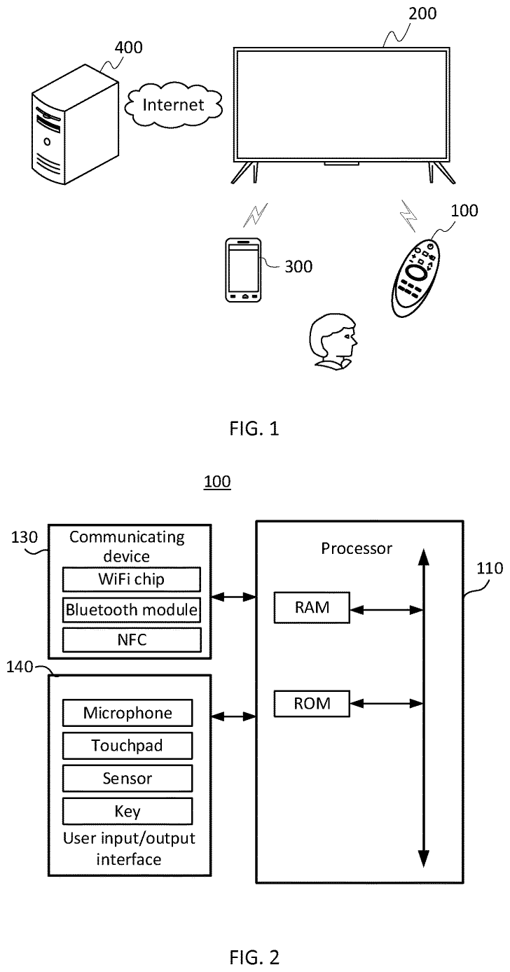

FIG. 1 is a schematic diagram of an operation scenario between a display device and a control device according to some embodiments. As shown in FIG. 1, a display device can be operated by a user through a mobile terminal 300 and a control device 100.

In some embodiments, the control device 100 can be a remote controller, and the communication between the remote controller and the display device can include infrared protocol communication or Bluetooth protocol communication, and other short-range communication methods, and the display device can be controlled wirelessly or wired. User commands can be input by the user through buttons on the remote controller, voice input, control panel input, etc., to control the display device.

In some embodiments, a smart device (such as a mobile terminal, a tablet computer, a computer, a laptop computer, etc.) can also be used to control the display device. For example, the display device can be controlled using an application running on the smart device.

In some embodiments, the display device may not use the above-mentioned smart device or control device to receive instructions, but may receive user control through touch or gestures.

In some embodiments, the display device can also be controlled in ways other than the control device 100 and the smart device. For example, the user's voice command control can be directly received through a module for obtaining voice commands configured inside the display device, or the user's voice command control can be received through a voice control device set outside the display device.

In some embodiments, the display device also communicates data with the server 400. The display device can be allowed to communicate via a local area network (LAN), a wireless local area network (WLAN), and other networks. The server 400 can provide various content and interactions to the display device 200. The server 400 can be a cluster or multiple clusters, and can include one or more types of servers.

FIG. 2 is a block diagram of a hardware configuration of a control device according to some embodiments. As shown in FIG. 2, the control device 100 can include a processor 110, a communicating device 130, a user input/output interface 140, a memory, and a power supply. The control device 100 can receive an input operation instruction from a user, and convert the operation instruction into an instruction that can be recognized and responded to by a display device, thereby acting as an interactive intermediary between the user and the display device.

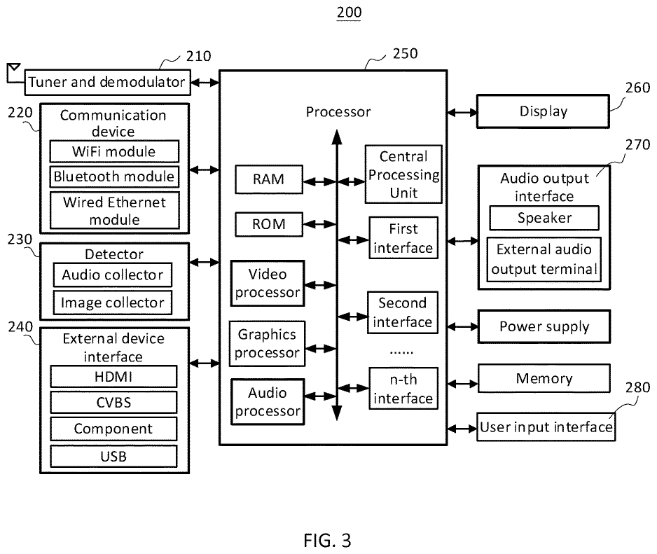

FIG. 3 is a block diagram of a hardware configuration of a display device according to some embodiments. As shown in FIG. 3, the display device can include at least one of a tuner and demodulator 210, a communicating device 220, a detector 230, an external device interface 240, at least one processor 250, a display 260, an audio output interface 270, a memory, a power supply, and a user input interface.

In some embodiments, at least one processor in the display device can include a video processor, an audio processor, a graphics processor, RAM, ROM, and first to nth interfaces for input/output. The display 260 can include a display screen component for presenting a picture, a driving component for driving an image display, a component for receiving an image signal output from the processor and displaying video content, image content, and a menu control interface, and a user control UI interface. The display 260 can be a liquid crystal display, an OLED display, and a projection display, and may also be a projection device and a projection screen.

The communicating device 220 is a component for communicating with an external device or server according to various types of communication protocols. For example, the communicating device can include at least one of a Wifi module, a Bluetooth module, a wired Ethernet module, and other network communication protocol chips or near field communication protocol chips, and an infrared receiver. The display device can establish transmission and reception of control signals and data signals with the external control device 100 or the server 400 through the communicating device 220.

The user input interface can be used to receive a control signal from the control device 100 (e.g., an infrared remote controller, etc.).

The detector 230 is used to collect signals from the external environment or the external interaction. For example, the detector 230 can include a light receiver, a sensor for collecting the intensity of ambient light; or, the detector 230 can include an image collector, such as a camera, which can be used to collect external environment scenes, user attributes or user interaction gestures; or, the detector 230 can include a sound collector, such as a microphone, etc., for receiving external sounds.

The external device interface 240 can include, but is not limited to, any one or more of the following interfaces: a high-definition multimedia interface (HDMI), an analog or digital high-definition component input interface (component), a composite video input interface (CVBS), a USB input interface (USB), an RGB interface, etc. It may also be a composite input/output interface formed by the above multiple interfaces.

The tuner and demodulator 210 receives broadcast television signals via wired or wireless reception, and demodulates audio and video signals, such as EPG data signals, from a plurality of wireless or wired broadcast television signals.

In some embodiments, at least one processor 250 and the tuner and demodulator 210 can be located in different separate devices, that is, the tuner and demodulator 210 can also be located in an external device of the main device where the at least one processor 250 is located, such as an external set-top box.

In some embodiments, at least one processor 250 can control the operation of the display device and respond to user operations through various software control programs stored in the memory. At least one processor 250 can control the overall operation of the display device, for example, in response to receiving a user command for selecting a UI object to be displayed on the display 260, at least one processor 250 performs operations related to the object selected by the user command.

In some embodiments, at least one processor in the display device can include a central processing unit (CPU), a video processor, an audio processor, a graphics processing unit (GPU), random access memory (RAM), read-only memory (ROM), a first interface to an nth interface for input/output, a communication bus (Bus), etc.

The user can input a user command through a graphical user interface (GUI) displayed on the display 260, and the user input interface receives the input user command through the GUI. Alternatively, the user can input a user command through a specific sound or gesture, and the user input interface recognizes the sound or gesture through a sensor to receive the input user command.

“User interface” is a medium interface for interaction and information exchange between an application or operating system and a user. It realizes the conversion between the internal form of information and the form acceptable to the user. The commonly used form of user interface is the graphical user interface (GUI), which refers to a user interface related to computer operation displayed in a graphical way. It can be an interface element such as an icon, window, control, etc., displayed on the display screen of an electronic device. Among them, the aforementioned controls can include visual interface elements such as icons, buttons, menus, tabs, text boxes, dialog boxes, status bars, navigation bars, widgets, etc.

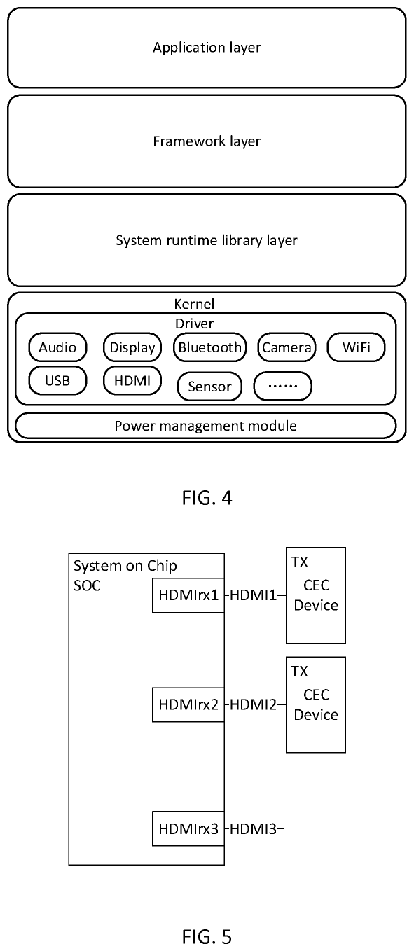

FIG. 4 is a software configuration block diagram of a display device according to some embodiments. As shown in FIG. 4, the system of the display device is divided into three layers, namely, an application layer, a middleware layer, and a hardware layer from top to bottom.

The application layer mainly includes commonly used applications on TV and an application framework. Here, the commonly used applications are mainly applications developed based on browsers, such as HTML5 APPs, and native applications (Native APPs).

The application framework is a complete program model that has all the basic functions required by standard application software, such as file access, data exchange, etc., as well as the user interfaces of these functions (toolbars, status bars, menus, dialog boxes).

The native applications can support online or offline, message push or local resource access.

The middleware layer can include various middleware, such as TV protocols, multimedia protocols, and system components, etc. The middleware can use the basic services (functions) provided by the system software to connect various parts of the application system or different applications on the network, and can achieve the purpose of resource sharing and function sharing.

The hardware layer mainly includes HAL interface, hardware and driver. HAL interface is the unified interface for all TV chips to connect, and the specific logic is implemented by each chip. Drivers mainly include audio driver, display driver, Bluetooth driver, camera driver, WIFI driver, USB driver, HDMI driver, sensor driver (such as fingerprint sensor, temperature sensor, pressure sensor, etc.), and power driver.

In order to clearly explain the technical solutions of the present disclosure, the terms of the present disclosure are first explained below.

CEC is consumer electronics control, which allows terminal users to use one remote control to control multiple CEC-enabled High Definition (HD) devices, eliminating the need to use multiple remote controls to control electronic devices such as televisions (TVs), set-top boxes, and portable HD devices.

In order to interact with external devices, the display device is provided with extended display identification data (EDID). EDID is a standard data format of the video electronics standards association (VESA), which contains some information of the display device, such as manufacturer information of the display device, a supported display resolution, a supported sound format, and a sound channel, etc. The storage method of EDID can include two methods: built-in and external. The built-in EDID method refers to writing the EDID data in the program. When the smart TV is powered on by DC, the EDID data is written into the electrically erasable programmable read-only memory (EEPROM) chip. When it is used, the EDID data of the smart TV is obtained from the EEPROM chip. The external EDID method refers to writing the EDID data directly into the external EEPROM chip, which is directly read by the external device through the display data channel without being controlled by the main program of the smart TV.

HDMI, namely high definition multimedia interface, is a digital video/audio interface technology, a dedicated digital interface suitable for image transmission, which can transmit audio and image signals at the same time, with a maximum data transmission speed of 48 Gbps (version 2.1), and no digital/analog or analog/digital conversion is required before signal transmission. The HDMI interface has hot-swappable function.

HPD, namely hot plug detection, is designed to achieve hot plugging of HDMI connections. Simply put, when the transmitter is connected to the receiver, the receiver responds to the HPD signal to the transmitter, and then the transmitter will start the DDC channel, read the EDID information of the receiver, and then perform high-bandwidth digital content protection (HDCP) interaction. If the authentication of both parties is successful, the video and audio will work normally, otherwise the connection fails and different systems will have different processing.

SOC, namely system on chip, a chip-level system, is also called a system on a chip. The SOC is a system or product formed by combining multiple integrated circuits with specific functions on a chip, and includes a complete hardware system and its embedded software. In the embodiments of the present disclosure, the SOC detects whether the device is connected and reads the EDID information.

DDC, namely digital display channel is an information channel between CEC devices and display devices. Through the information channel, the display device can directly transmit the physical data of its display to the CEC device.

After the CEC device inputs an HDMI signal to the display device, if the display device supports the SCDC function, the CEC device will perform SCDC interaction with the display device. Then the CEC device will determine whether there is an abnormality in the interaction between the display device and the CEC device based on the value generated during the SCDC interaction.

In some embodiments, an audio and video terminal is provided with a main board integrated with a plurality of HDMI interfaces for receiving audio and video data transmitted from external signal sources. Limited by the physical layout and circuit design of the main board, the display device is equipped with N native HDMI interfaces, where N is an integer greater than or equal to 1. For example, N is commonly set to three or four. When the number of CEC devices to be connected exceeds N, all devices cannot be directly connected via the native HDMI interfaces of the device.

This inherent configuration gives rise to a technical problem: when the number of external signal source devices that a user needs to connect exceeds the number N of native interfaces of the device, direct connection and seamless management of all devices cannot be realized.

An external HDMI switching device is used to logically expand at least one limited native HDMI physical channel on the display device into an addressable virtual channel pool, so as to dynamically support connection of more external signal source devices or CEC devices.

In some embodiments, when the display device is only provided with an HDMI native interface, its SOC hardware circuit diagram can be shown in FIG. 5. The circuit shown in FIG. 5 includes HDMI native interfaces: HDMIrx1, HDMIrx2, and HDMIrx3. In this configuration, the CEC device can access the display device through the HDMI native interface. Since there is no switch and no intermediate switching circuit between the CEC device and the display device, the CEC device can directly interact with the display device for SCDC, and the communication path is the most direct.

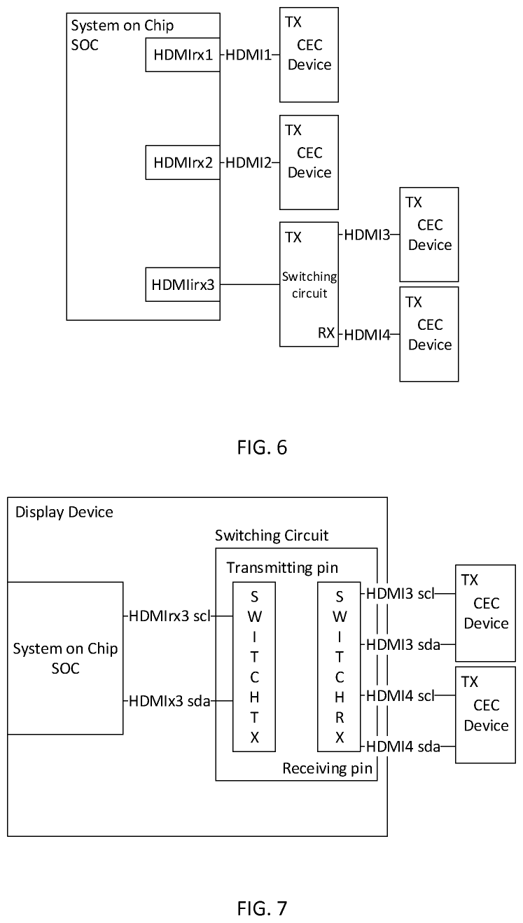

In addition, when the display device is provided with both an HDMI native interface and an HDMI extension interface, its SOC hardware circuit is different, as shown in FIG. 6. The circuit shown in FIG. 6 includes not only HDMI native interfaces: HDMIrx1, HDMIrx2, and HDMIrx3, but also HDMI extension interfaces from additional circuits: HDMI3 and HDMI4. In this architecture, when the CEC device is connected to the display device through the HDMI extension interface, a switching circuit is disposed between the CEC device and the display device. Therefore, when the CEC device (such as CEC device 3 connected to HDMI_3) accesses through the extension interface, the communication link between the CEC device and the SoC includes the switching circuit. As a result, the CEC device cannot directly interact with the display device for SCDC and has to relay signals through the switching circuit.

FIG. 7 is a hardware circuit diagram of an SOC including a switching circuit according to some embodiments. As shown in FIG. 7, the switching circuit is usually provided with specific pins for data and signal transmission and reception, namely the transmitting pin SwitchTX and the receiving pin SwitchRX mentioned above.

When the display device interacts with the CEC device for SCDC through the extension interface, it needs to go through two levels of SCDC interaction of SwitchTX and SwitchRX, that is, the interaction process needs to go through SwitchTX and SwitchRX to transfer data and signals, such indirect relay path inevitably increases the processing time of the SCDC interaction protocol, thereby resulting in a longer SCDC interaction time, affecting the efficiency of the CEC device outputting audio and video signals to the display device.

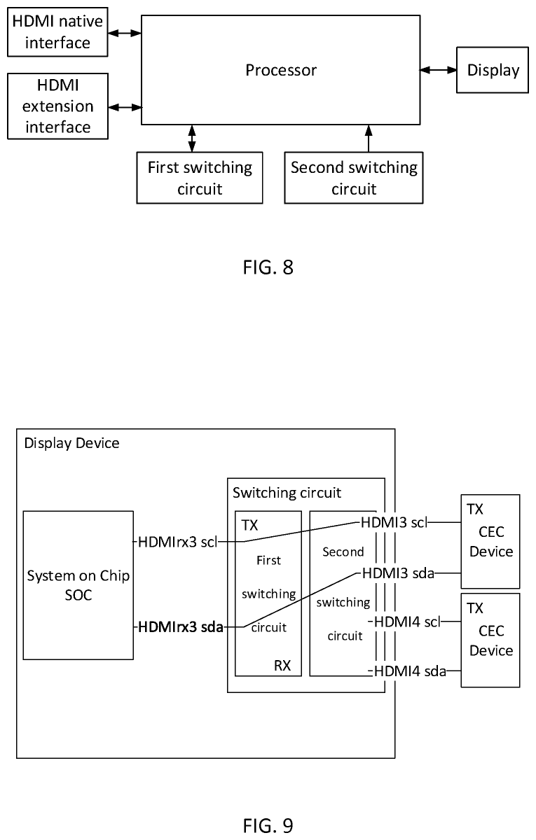

In view of this, embodiments of the present disclosure provide a display device. FIG. 8 is a hardware connection block diagram of some functional modules of the display device provided by the embodiments of the present disclosure. As shown in FIG. 8, the display device of the embodiments of the present disclosure mainly includes the following functional modules: at least one processor (including SOC and registers), a display, an HDMI native interface, an HDMI extension interface, a first switching circuit, and a second switching circuit. It should be understood that the functional modules mentioned above are only for the purpose of illustrating the modules described in the scheme, rather than for implementing all the functional modules of the present disclosure.

At least one processor of the display device is the control and signal processing core of the entire display device. It is responsible for controlling the operation of the entire display device system, including receiving external image signals, image signal decoding, image quality processing, image signal output, controlling the operation of the backlight component, and ensuring the normal operation of peripheral devices or components such as Wi-Fi and Bluetooth.

The display is used to display the video screen. The CEC module is used to use the HPD event to perform CEC interaction with the CEC device, that is, to send and receive CEC messages with the CEC device. The CEC module may specifically include the CEC protocol stack in the embodiments of the present disclosure. In addition, the display device should also include a power supply (not shown in the figure), which is the power output module of the entire display device and provides power guarantee for all modules of the display device.

In some embodiments, the HDMI extension interface can be communicatively connected to the HDMI native interface via a switching circuit, and the switching circuit can include the aforementioned first switching circuit and second switching circuit.

The first switching circuit (i.e., the circuit including SwitchTX and SwitchRX as mentioned above, as shown in FIG. 7) is provided with dedicated transmitting and receiving pins (namely SwitchTX and SwitchRX) for SCDC interaction. It is mainly configured to process the hot plug detection (HPD) link and transmit and receive SCDC interaction trigger signals. When a CEC device is plugged into the HDMI extension interface, the first switching circuit (specifically, through its SwitchRX pin) sends SCDC interaction trigger signals to the CEC device.

The second switching circuit (e.g., Port Switch) does not include SwitchTX and SwitchRX pins. It serves purely for data channel switching, and is specifically configured to establish a direct display data channel connection between the SoC and a designated HDMI extension interface.

FIG. 9 is a hardware circuit diagram of a display device provided by embodiments of the present disclosure. In the display device of the embodiments of the present disclosure, the connection relationship between the HDMI extension interface and the HDMI native interface can be shown in FIG. 9. The HDMI extension interfaces are HDMI3 and HDMI4, and a communication connection is established with the HDMI native interface HDMIrx3 through a switching circuit. Here, the first switching circuit includes SwitchTX and SwitchRX (the form can be seen in the switching circuit of FIG. 7), and the second switching circuit does not include SwitchTX and SwitchRX, so the second switching circuit is a switching circuit that can directly switch the signal source. That is, the signal source can be switched without the need to transfer the signal through SwitchTX and SwitchRX. In some embodiments, the first switching circuit and the second switching circuit operate cooperatively while performing different functions. In some embodiments, the second switching circuit can be a Port Switch.

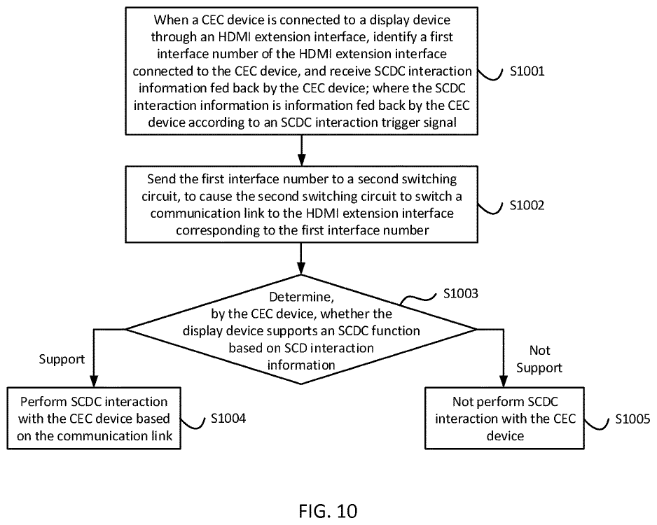

Based on the functional modules shown in FIG. 8 and the circuit connection block diagram shown in FIG. 9, the embodiments of the present disclosure further provide a device control method, which can include the following steps as shown in FIG. 10.
S1001, When a CEC device is connected to a display device through an HDMI extension interface, identifying a first interface number of the HDMI extension interface connected to the CEC device, and receiving SCDC interaction information fed back by the CEC device; where the SCDC interaction information is information fed back by the CEC device according to an SCDC interaction trigger signal.

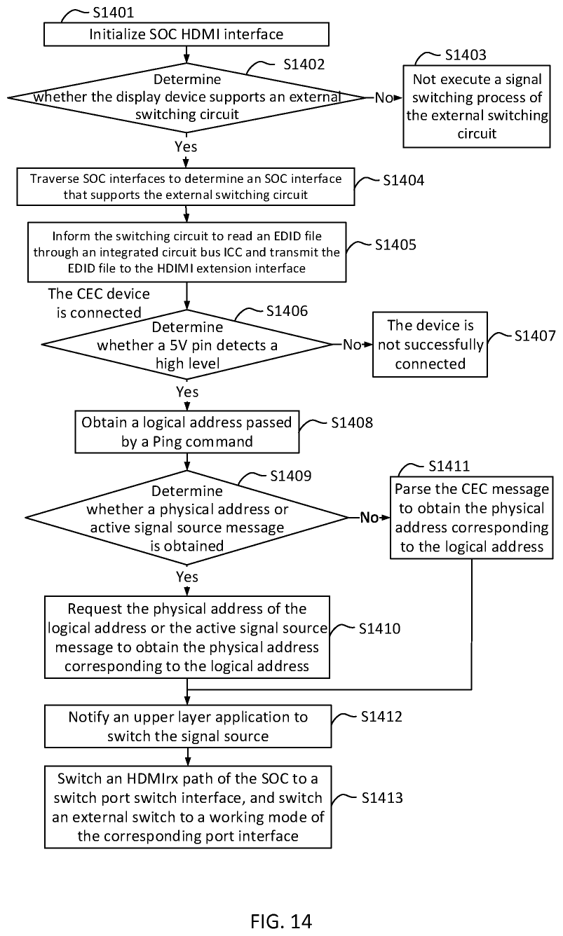

When the CEC device is connected to the display device through the HDMI extension interface, after the first switching circuit sends the SCDC interaction trigger signal to the CEC device, the CEC device feeds back SCDC interaction information to the display device according to the SCDC interaction trigger signal. Meanwhile, the specific HDMI extension interface (i.e., the first interface number) connected with the CEC device is identified. The identification method may include obtaining the physical address of the device based on the CEC protocol, and then determining the interface number according to a pre-stored mapping relationship (as shown in FIG. 14 and the related description below for details).

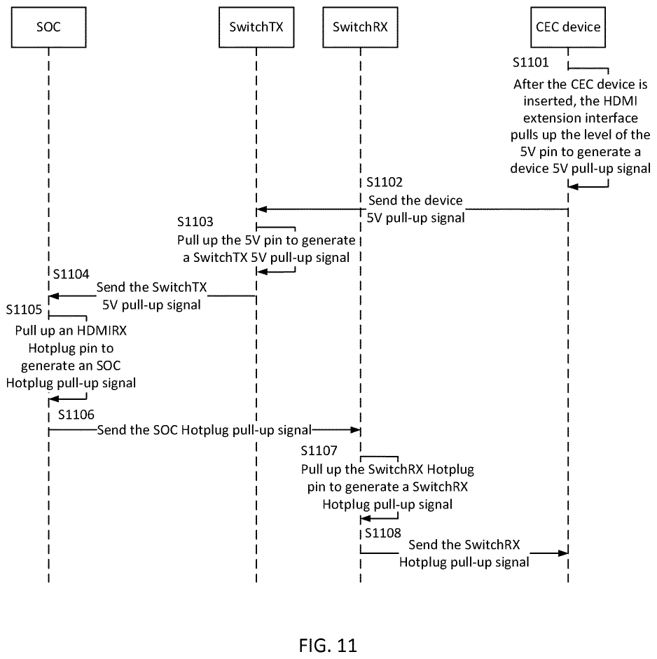

FIG. 11 shows a related process of sending an SCDC interaction trigger signal to the CEC device through the first switching circuit when the CEC device is connected to the display device through the HDMI extension interface, which can include the following steps.
S1101, After the CEC device is inserted, the HDMI extension interface pulls up the level of the 5V pin to generate a device 5V pull-up signal.
S1102, The device 5V pull-up signal is sent to SwitchTX.
S1103, SwitchTX pulls the 5V pin high to generate a SwitchTX 5V pull-up signal.
S1104, The SwitchTX 5V pull-up signal is sent to SOC.
S1105, SOC pulls up an HDMIRX Hotplug pin to generate an SOC Hotplug pull-up signal.
S1106, The SOC Hotplug pull-up signal is sent to SwitchRX.
S1107, SwitchRX pulls up the SwitchRX Hotplug pin to generate a SwitchRX Hotplug pull-up signal.
S1108, The SwitchRX Hotplug pull-up signal is sent to the CEC device.

In the process shown in FIG. 11, when the CEC device is connected to the display device through the HDMI extension interface (i.e., the CEC device is inserted into the display device), the HDMI extension interface first pulls up the level of its 5V pin, generates a device 5V pull-up signal, and sends the device 5V pull-up signal to the SwitchTX pin. After SwitchTX receives the device 5V pull-up signal, it pulls up its 5V pin at the same time. That is, the SwitchTX 5V is pulled up, and then a SwitchTX 5V pull-up signal is generated, and the SwitchTX 5V pull-up signal is sent to at least one processor of the display device, i.e., the SOC chip shown in FIG. 11.

The pin of SOC for hot-plug function (SOC Hotplug) will be in the pull-up state after SOC receives the 5v pull-up signal. This pin can be represented as HDMIRX Hotplug. After this pin is pulled up, the SOC Hotplug pull-up signal is generated. SOC sends the SOC Hotplug pull-up signal to SwitchRX pin. SwitchRX will pull up the SwitchRX Hotplug pin according to the SOC Hotplug pull-up signal, then generate the SwitchRX Hotplug pull-up signal, and send the SwitchRX Hotplug pull-up signal to the CEC device.

The SwitchRX Hotplug pull-up signal in the above process is the SCDC interaction trigger signal. The CEC device can feedback the SCDC interaction information to the display device according to the SCDC interaction trigger signal. That is, the CEC device receives the SwitchRX Hotplug pull-up signal of SwitchRX and feedbacks the SCDC interaction information to the display device.

After obtaining the SCDC interaction trigger signal, the CEC device also needs to determine whether the display device supports the SCDC function. Therefore, after receiving the SCDC interaction trigger signal sent by the display device, the CEC device also needs to send SCDC interaction information to the display device to confirm whether the display device supports the SCDC function. The SCDC interaction information includes at least an SCDC interaction request. After the CEC device sends the SCDC interaction request to the display device, the display device feeds back to the CEC device relevant information on whether the SCDC function is supported. For example, the SCDC interaction request can carry the value that the CEC device needs to write in the register; the SOC writes the value corresponding to whether the display device supports the SCDC function in the register based on the value written by the CEC device in the register.

It should be noted that the embodiments of the present disclosure are used to improve the interaction speed between the display device and the CEC device. Therefore, the embodiments of the present disclosure are based on the fact that the display device supports the SCDC function, and the special case that the display device does not support the SCDC function is automatically excluded.

Here, if the display device is only configured with an HDMI native interface, as shown in the hardware circuit diagram of FIG. 5 above, the HDMI native interface is only connected to an HDMI processor. If the CEC device uses the HDMI native interface to access the display device, since the HDMI native interface has a corresponding relationship with the HDMI processor, the HPD pull-up signal generated by the HDMI processor is used to clearly determine which HDMI native interface the current CEC device is connected to. After determining the connected HDMI native interface, the display device can use the determined HDMI native interface to establish an HDMI channel, and then use the established HDMI channel to establish a CEC connection with the CEC device.

Continuing as shown in the above FIG. 6, if the CEC device uses the HDMI native interface HDMIrx1 to access the display device, the HDMI processor connected to the HDMI native interface HDMIrx1 generates an HPD pull-up signal after detecting the access of the CEC device. Based on the identification of the HDMI processor that generates the HPD pull-up signal, based on the mapping relationship, it can be determined that the HDMI interface accessed by the CEC device is HDMIrx1. Therefore, according to the interface HDMIrx1, an HDMI channel between the CEC device and the display device can be established, and a CEC connection between the CEC device and the display device can be established.

But if the display device is configured with an HDMI extension interface in addition to the HDMI native interface. For example, the circuit diagram shown in the aforementioned FIG. 6 shows not only the HDMI native interface, but also the HDMI extension interfaces: HDMI3 and HDMI4. The HDMI native interface HDMIrx3 is connected to the HDMI extension interfaces: HDMI3 and HDMI4 through a switching circuit. Then, when the CEC device uses the HDMI extension interface to access the display device, since the HDMI native interface HDMIrx3, the HDMI extension interface HDMI3, and the extension interface HDMI4 share a HDMI processor, it is not certain whether HDMIrx3 recognizes the access as the extension interface HDMI3 or the extension interface HDMI4. It can be seen that after the HDMI native interface HDMIrx3 recognizes the access, it is also necessary to determine whether the extension interface HDMI3 or the extension interface HDMI4 is accessed.

In some embodiments, the display device can use CEC signals to control external devices connected to the HDMI interface, and the controlled external devices are called CEC devices. After the CEC device is connected to the display device through the HDMI interface, the display device needs to use CEC instructions to obtain the device information of the CEC device, and then the display device uses the device information of the CEC device and the logical address of the CEC device to establish a connection with the CEC device.

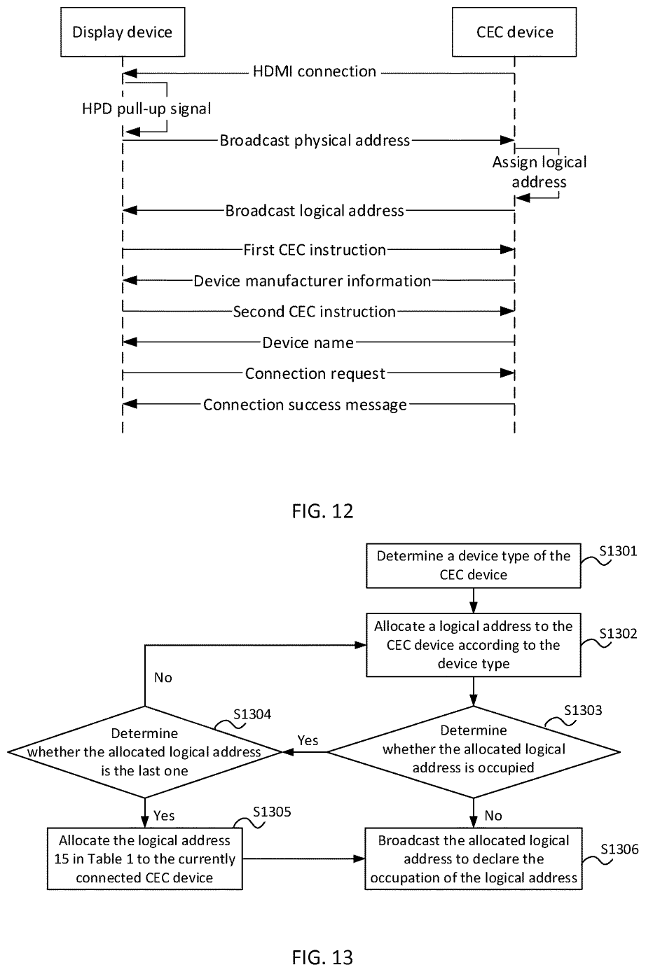

For example, FIG. 12 shows the interaction flow chart between the display device and the CEC device, since the HDMI interface has a hot-plug function, when the CEC device is connected to the display device through the HDMI interface, the display device uses the hot-plug function to detect the access action of the CEC device. The system hardware of the display device will trigger the HotPlug pull-up signal, and through the HotPlug pull-up signal, the display device knows that a CEC device is connected. After receiving the HotPlug pull-up signal, the display device will broadcast its own physical address to the outside, and all CEC devices on the CEC line where the display device is located can obtain the physical address broadcast by the display device.

After the CEC device receives the physical address broadcast by the display device, it calculates its own logical address according to the HDMI standard protocol (usually the CEC line assigns an address to the CEC device), and broadcasts the assigned logical address. Here, CEC is a bus system-based protocol that assigns physical addresses through the physical address discovery process. When a device with CEC function obtains a new physical address, it will perform the following steps: applying for an allocation of a logical address corresponding to a device type of the CEC device; and reporting the binding of its physical address and the logical address through broadcast (Report Physical Address). The types of logical addresses can be shown in Table 1.

TABLE 1
Types of Logical Addresses

| Address (Logical Address) | Device |
|---|---|
| 0 | TV (Display Device) |
| 1 | Recording Device 1 (Camera Device 1) |
| 2 | Recording Device 2 (Camera Device 2) |
| 3 | Tuner1 |
| 4 | Playback Device 1 |
| 5 | Audio System |
| 6 | Tuner 2 |
| 7 | Tuner 3 |
| 8 | Playback Device 2 |
| 9 | Recording Device 3 (Camera Device 3) |
| 10 | Tuner4 |
| 11 | Playback Device 3 |
| 12 | Reserved (Reserved Interface) |
| 13 | Reserved |
| 14 | Specific Use |
| 15 | Unregistered (as Initiator address) |
| | Broadcast (as Destination address) |

The logical address of the CEC device is also dynamically allocated. As shown in FIG. 13, the logical address allocation method of the CEC device can include the following steps.
S1301, Determining a device type of the CEC device.
S1302, Allocating a logical address to the CEC device according to the device type.
S1303, Determining whether the allocated logical address is occupied.
S1304, If it is occupied, determine whether the allocated logical address is the last one.
S1305, If it is the last one, allocating the logical address 15 in Table 1 to the currently accessed CEC device; if it is not the last one, returning to the step S1302 to reallocate the logical address.
S1306, If it is not occupied, broadcasting the allocated logical address to declare the occupation of the logical address.

The root node (usually a display device) is directly provided with a logical address of 0. When a CEC device is inserted into a display device, a first preset logical address is allocated to the CEC device according to the device type of the inserted CEC device. For example, if the CEC device is a DVD and the device type is Playback Device 1, the CEC device needs to be assigned a first preset logical address of 4 according to Table 1, and the first preset logical address is broadcast to other CEC devices through broadcasting. If the first preset logical address 4 is not occupied, the currently connected CEC device will not receive a response confirmation message.

If the first preset logical address 4 has been occupied, the CEC device occupying the first preset logical address 4 will feed back a response confirmation message to the currently connected CEC device, and the response confirmation message is used to inform the currently connected CEC device that the first preset logical address 4 has been occupied. After receiving the response confirmation message, the currently connected CEC device continues to be allocated a logical address according to Table 1 until no response confirmation message is received from other CEC devices after allocating the logical address.

For example, a second preset logical address 8 is assigned to the currently connected CEC device. After broadcasting this logical address, if no response confirmation message is received from other CEC devices, it means that the second preset logical address 8 is not occupied, so the currently connected CEC device can occupy the second preset logical address 8. After the currently connected CEC device occupies the second preset logical address 8, it sends a broadcast “Report Physical Address”, which includes the physical address and logical address of the currently connected CEC device. The broadcast is used to declare the occupation of the second preset logical address 8 to other CEC devices. If all logical addresses are occupied after a round of inquiry according to Table 1, the logical address 15 in Table 1 is allocated to the currently connected CEC device.

After the display device receives the logical address of the CEC device, the display device adds the logical address of the CEC device to the device list in the system of the display device, and sends a first CEC instruction to the CEC device, where the first CEC instruction is used to request the manufacturer information of the CEC device. After the CEC device receives the first CEC instruction, the CEC device feeds back the manufacturer information of the CEC device to the display device. Then the display device continues to send a second CEC instruction to the CEC device, where the second CEC instruction is used to request a device name of the CEC device. After the CEC device receives the second CEC instruction, the CEC device feeds back the device name of the CEC device to the display device. After obtaining the manufacturer information and device name of the CEC device, the display device can send a connection request to the CEC device. When the CEC device feeds back a connection success message according to the connection request, the display device and the CEC device are connected.

It should be noted that in the same CEC line, the CEC of all CEC devices is hanging on the same line. Therefore, after the CEC of the display device sends a CEC instruction, all CEC devices in the line can receive the CEC instruction. Here it is necessary to distinguish which CEC device the CEC instruction is sent to according to the logical address. The logical address exists in the header data of the CEC instruction. If the logical address included in the header data of the CEC instruction matches its logical address, the corresponding CEC device will perform the corresponding execution action on operation codes in the CEC instruction. If the logical address included in the header data of the CEC instruction does not match its logical address, the corresponding CEC device will ignore this CEC instruction.

For example, the CEC instruction is a standby instruction, and the content of the instruction is “start signal+00FF+0x36”, where: 00 represents the logical address of the display device, FF represents a broadcast address (that is, a logical address set of all CEC devices), and 0x36 represents a standby operation. This instruction is a CEC instruction sent by the display device to all CEC devices, indicating that the display device informs all CEC devices to enter a standby state. CEC devices on the same CEC line as the display device enter the standby state after receiving this instruction.

It can be seen that when a CEC device is connected to a display device, a physical address (dynamic allocation) needs to be allocated, and the physical address is information identified by DDC/EDID. Since the EDID of each HDMI interface of the display device has been determined and written, and the physical address of each HDMI interface is written in the EDID, when the CEC device is connected to the display device and the EDID is read through the DDC channel, the physical address of the CEC device has been determined. Therefore, the HDMI extension interface connected to the CEC device can be determined by the physical address of the CEC device requested to be connected.

Based on the above principle, the specific process of identifying the first interface number of the HDMI extension interface connected to the CEC device can be shown in FIG. 14, including the following steps.
S1401, Initialize SOC HDMI interface.
S1402, Determine whether the display device supports an external switching circuit.
S1403, If not supported, a signal switching process of the external switching circuit is not executed.
S1404, If supported, traverse SOC interfaces to determine an SOC interface that supports the external switching circuit.
S1405, Inform the switching circuit to read an EDID file through an integrated circuit bus ICC and transmit the EDID file to the HDIMI extension interface.
S1406, After the CEC device is connected, determine whether a 5V pin detects a high level.
S1407, If not detected, it is determined that the device is not successfully connected.
S1408, If detected, obtain a logical address passed by a Ping command.
S1409, Determine whether a physical address or active signal source message is obtained.
S1410, If yes, request the physical address of the logical address or the active signal source message to obtain the physical address corresponding to the logical address.
S1411, If not, parse the CEC message to obtain the physical address corresponding to the logical address.
S1412, Notify an upper layer application to switch the signal source.
S1413, Switch an HDMIrx path of the SOC to a switch port switch interface, and switch an external switching circuit to a working mode of the corresponding port interface.

After the SOC HDMI interface is initialized, it determines whether the display device supports an external switching circuit. If it is determined that the display device does not support the external switching circuit, a normal signal source switching process is performed (identifying an HDMI native interface and then switching to the HDMI native interface). If it is determined that the display device supports the external switching circuit, the SOC interface is traversed and the SOC interface that supports the external switching circuit is selected.

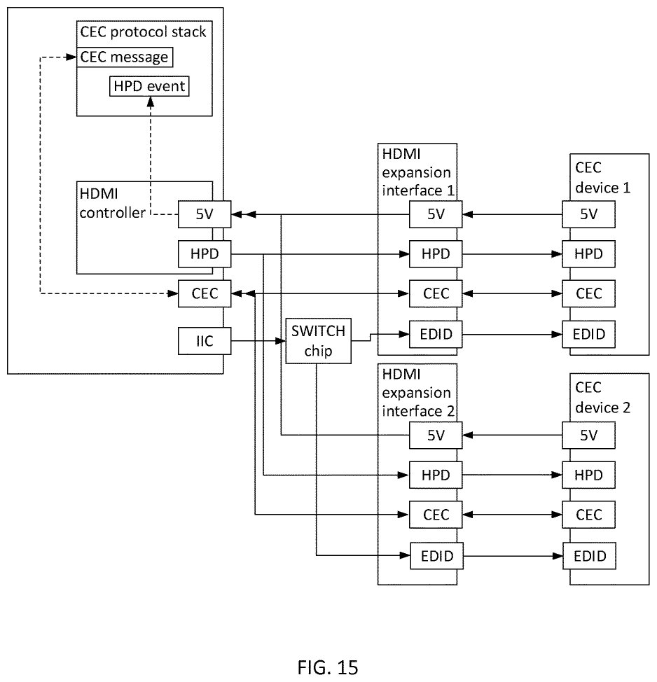

In the embodiments of the present disclosure, for different CEC devices connected to different HDMI interfaces, different EDID information needs to be transmitted to the CEC devices according to the different interface capabilities of the HDMI interfaces. The implementation method can be shown in FIG. 15. The SOC chip of the display device reads different EDID files from the switching circuit through IIC (Inter-Integrated Circuit, integrated circuit bus), and then the switching circuit transmits the EDID files to different HDMI interfaces. After the CEC device is connected, it will actively read the corresponding EDID file. Before the SOC chip transmits the EDID file to the switching circuit, it needs to determine the interface capability of the HDMI interface. The interface capability includes the playback format and playback rate supported by the interface. After obtaining the interface capability of the HDMI interface, the EDID file corresponding to the interface capability is transmitted to the corresponding HDMI interface. The CEC device is connected to the display device through the HDMI interface, that is, it can read the EDID file that matches the interface capability of the corresponding HDMI interface.

Therefore, when the CEC device is connected to different HDMI extension interfaces, the EDID file that matches the connected HDMI extension interface can be read. After the CEC device is connected to the display device through the HDMI extension interface, if the SOC 5V does not detect a high level, the display device determines that there is no CEC device connected. If the SOC 5V detects a high level, it traverses the logical addresses that are pinged (the ping command is a command to detect whether there is data transmission with the input logical address), and then obtain the pinged logical address. If the physical address or active source message is not obtained, the CEC message can be directly parsed to obtain the physical address corresponding to the pinged logical address (the physical address of the HDMI extension interface connected to the CEC device). If the physical address or active source message is obtained, it is necessary to request the pinged logical address or active source message, and then parse the CEC message to obtain the physical address corresponding to the pinged logical address.

Since the mapping relationship between the physical address and the interface number of the HDMI extension interface is stored in the processor, the interface number with the mapping relationship with the physical address can be searched from the mapping table according to the physical address of the accessed CEC device, thereby identifying the HDMI extension interface of the accessed CEC device. For example, in the mapping table, there is a mapping relationship between physical address 1 and HDMI extension interface HDMI3, and there is a mapping relationship between physical address 2 and HDMI extension interface HDMI4. Then, when the CEC device is connected to the display device, the physical address corresponding to the pinged logical address is obtained as physical address 1, and the HDMI extension interface HDMI3 is mapped to physical address 1. Therefore, it can be determined that the HDMI extension interface HDMI3 is currently connected to the CEC device.
S1002, Sending the first interface number to a second switching circuit, to enable the second switching circuit to switch a communication link to the HDMI extension interface corresponding to the first interface number.

Specifically, the identified first interface number is sent to the second switching circuit. In response the identified first interface number, the second switching circuit performs a switching operation to directly connect a DDC channel (including the SCL line and the SDA line) between an HDMI controller of SoC and an HDMI extension interface corresponding to the first interface number. A direct communication link is established between the SoC and the CEC device.
S1003, Determining, by the CEC device, whether the display device supports an SCDC function based on SCD interaction information.
S1004, If the SCDC function is supported, performing SCDC interaction with the CEC device based on the communication link.
S1005, If the SCDC function is not supported, not performing SCDC interaction with the CEC device.

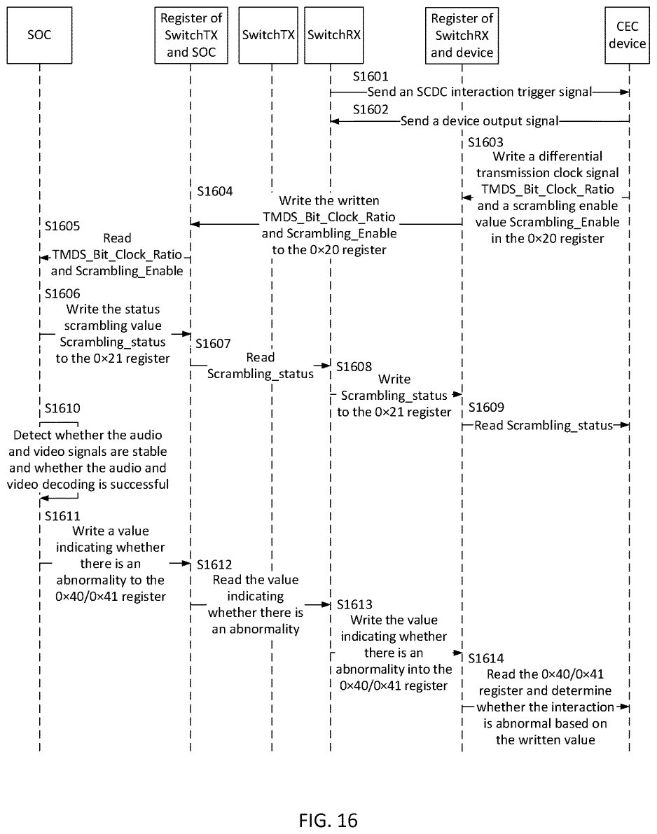

FIG. 16 is a flow chart of performing SCDC interaction through a first switching circuit according to some embodiments. As shown in FIG. 16, the following steps can be included.
S1601, SwitchRX sends an SCDC interaction trigger signal to the CEC device.
S1602, The CEC device sends a device output signal to SwitchRX.
S1603, The CEC device writes a differential transmission clock signal TMDS_Bit_Clock_Ratio and a scrambling enable value Scrambling_Enable in the 0x20 register of the SwitchRX and device.

If the first interface number is sent to the first switching circuit, and then the communication link is switched to the HDMI extension interface corresponding to the first interface number using the first switching circuit, since the first switching circuit includes SwitchTX and SwitchRX, two levels of interaction, SwitchTX and SwitchRX, are required during SCDC interaction.

For example, after the CEC device inputs audio and video signals to the display device, the CEC device first needs to write the values of TMDS_Bit_Clock_Ratio and Scrambling_Enable in the 0x20 register of the SwitchRX and device. The format of the 0x20 register is shown in Table 2.

TABLE 2
TMDS (Transition-minimized differential signaling) configuration

| Offset | Bit7 | . . . | Bit1 | Bit0 |
|---|---|---|---|---|
| 0 × 20 | Rsvd (0) | . . . | TMDS_Bit_Clock_{—} | Scrambling_Enable |
| | | | Ratio | |

Here, the values of Scrambling_Enable and TMDS_Bit_Clock_Ratio are set by the CEC device. When the CEC device sets the value of Scrambling_Enable to 1, scrambling on the display device side is enabled. When the CEC device sets the value of

Scrambling_Enable to 0, scrambling on the display device side is disabled. When the TMDS bit rate supported by the display device is greater than 3.4 Gbps, the TMDS_Bit_Clock_Ratio control bit needs to be provided. If the TMDS bit rate is less than 3.4 Gpbs, the CEC device needs to set TMDS_Bit_Clock_Ratio=0, and the TMDS clock and data signals need to comply with HDMI1.4b. When the TMDS bit rate ranges from 3.4 to 6.0 Gbps, the CEC device needs to set TMDS_Bit_Clock_Ratio=1, and the TMDS clock and data signals need to comply with 6.1.1.4 of HDMI2.0. Once set, the CEC device can read the Clock_Detected status bit to ensure that the display device received the transmitted TMDS_Bit_Clock_Ratio setting.
S1604, The registers of SwitchRX and the device write the written TMDS_Bit_Clock_Ratio and Scrambling_Enable to the 0x20 register of switching circuit and SOC.
S1605, SOC reads TMDS_Bit_Clock_Ratio and Scrambling_Enable.
S1606, SOC writes the status scrambling value Scrambling_status to the 0x21 register of the switching circuit and the device.
S1607, SwitchRX reads Scrambling_status.
S1608, SwitchRX writes Scrambling_status to the 0x21 register of SwitchRX and the device.
S1609, The CEC device reads Scrambling_status.

After the CEC device is written in the 0x20 register of SwitchRX and the device, the 0x20 register of SwitchRX and the device also needs to write the written TMDS_Bit_Clock_Ratio and Scrambling_Enable values to the 0x20 register of SwitchTX and SOC. SOC reads the values of TMDS_Bit_Clock_Ratio and Scrambling_Enable from the 0x20 register of SwitchTX and SOC, and then writes the Scrambling_status value to the 0x21 register of SwitchTX and SOC.

The format of the 0x21 register is shown in Table 3.

TABLE 3
Status Flags configuration

| Offset | Bit7 | . . . | Bit1 | Bit0 |
|---|---|---|---|---|
| 0 × 21 | Rsvd (0) | . . . | Rsvd (0) | Scrambling_status |

SwitchRX reads the value of Scrambling_status from the 0x21 register of SwitchTX and SOC, and then writes the read value of Scrambling_status into the 0x21 register of SwitchRX and the device. Finally, the CEC device reads the value of Scrambling_status from the 0x21 register of SwitchRX and the device.
S1610, SOC detects whether the audio and video signals are stable and whether the audio and video decoding is successful.
S1611, SOC writes a value indicating whether there is an abnormality to the 0x40/0x41 register of SwitchTX and SOC.
S1612, SwitchRX reads the value indicating whether there is an abnormality.
S1613, SwitchRX writes the value indicating whether there is an abnormality into the 0x40/0x41 register of SwitchRX and the device.
S1614, CEC device reads the 0x40/0x41 register and determines whether the interaction is abnormal based on the written value.

If the SOC detects a scrambling code, the SOC writes the Scrambling_status value of 1 to the 0x21 register of SwitchTX and SOC, so the CEC device can also read the Scrambling_status value of 1, so the CEC device can determine that the display device supports the SCDC function based on this value. If the SOC does not detect a scrambling code, the SOC writes the Scrambling_status value of 0 to the 0x21 register of SwitchTX and SOC, so the CEC device can also read the Scrambling_status value of 0, so the CEC device can determine that the display device does not support the SCDC function based on this value. After determining that the display device supports the SCDC function, the CEC device can obtain the detection value from the SOC to determine whether there is an abnormality in the signal interaction between the CEC device and the display device. Specifically, if the SOC recognizes that the audio and video signals are stable and the audio and video decoding is successful, the SOC writes the corresponding value of no abnormality to the 0x40/0x41 register of SwitchTX and SOC.

After SwitchRX reads the value corresponding to no abnormality from the 0x40/0x41 register of SwitchTX and SOC, SwitchRX writes the value corresponding to no abnormality into the 0x40/0x41 register of SwitchRX and the device. Finally, the CEC device can read the value corresponding to no abnormality from the 0x40/0x41 register of SwitchRX and the device, and judge that the signal interaction between the CEC device and the display device is normal according to the value corresponding to no abnormality, and the CEC device can continue to input audio and video signals to the display device.

If the SOC recognizes that the audio and video signals are unstable or the audio and video decoding is unsuccessful, a value corresponding to abnormality is written to the 0x40/0x41 register of SwitchTX and SOC. After SwitchRX reads the value corresponding to the abnormality from the 0x40/0x41 register of SwitchTX and SOC, SwitchRX writes the value corresponding to the abnormality to the 0x40/0x41 register of SwitchRX and the device. Finally, the CEC device can read the value corresponding to the abnormality from the 0x40/0x41 register of SwitchRX and the device, judge the abnormality in signal interaction between the CEC device and the display device according to the value corresponding to the abnormality, and then the CEC device can stop inputting audio and video signals to the display device.

It should be noted that no matter when the SOC recognizes that the audio and video signal is unstable or the audio and video decoding is unsuccessful, the CEC device can read the value corresponding to the abnormality from the register. If the CEC device needs to read the value corresponding to no abnormality from the register, it is necessary to ensure that the SOC recognizes that the audio and video signal is stable and the audio and video decoding is successful at the same time.

The format of the 0x40/0x41 register is shown in Table 4.

TABLE 4
Status Flags configuration

| Offset | Bit7 | . . . | Bit3 | Bit2 | Bit1 | Bit0 |
|---|---|---|---|---|---|---|
| 0 × 40 | Rsvd (0) | . . . | Ch2_{—} | Ch1_{—} | Ch0_{—} | Clock_{—} |
| | | | Locked | Locked | Locked | Detected |
| 0 × 41 | Rsvd (0) | . . . | Rsvd (0) | Rsvd (0) | Rsvd (0) | Rsvd (0) |

Here, if the display device detects a valid clock signal (that is, the SOC recognizes that the audio and video signals are stable), the value of Clock_Detected is set to 1, and if the display device does not detect a valid clock signal (that is, the SOC recognizes that the audio and video signals are unstable), the value of Clock_Detected is set to 0. If the display device detects that data is successfully decoded on channel 0 (that is, the SOC recognizes that the decoding is successful), the value of Ch0_Locked is set to 1, and if the display device does not detect that data is successfully decoded on channel 0 (that is, the SOC recognizes that the decoding fails), the value of Ch0_Locked is set to 0. If the display device detects that data is successfully decoded on channel 1, the value of Ch1_Locked is set to 1, and if the display device does not detect that data is successfully decoded on channel 1, the value of Ch1_Locked is set to 0. If the display device detects that data is successfully decoded on channel 2, the value of Ch2_Locked is set to 1, and if the display device does not detect that data is successfully decoded on channel 2, the value of Ch2_Locked is set to 0. It should be noted that only one of the channels 1, 2 and 3 needs to have its ChX_Locked value set to 1, and the CEC device can determine that the data is successfully decoded on the display device.

It can be seen that if the first switching circuit is used to establish a communication link between the CEC device and the display device, not only does it need to transfer data between SwitchTX and SwitchRX, but it also needs to configure two registers: the register of SwitchRX and the device and the register of SwitchTX and the SOC, which leads to a longer SCDC interaction time.

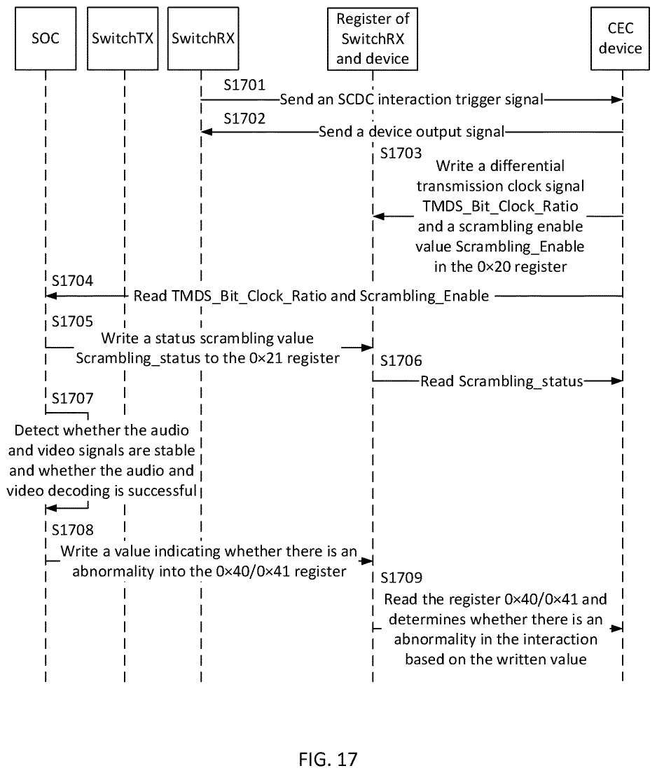

FIG. 17 is a flow chart of performing communication link switching and SCDC interaction through a second switching circuit according to some embodiments. As shown in FIG. 17, the following steps can be included.
S1701, SwitchRX sends an SCDC interaction trigger signal to the CEC device.
S1702, The CEC device sends a device output signal to SwitchRX.
S1703, The CEC device writes a differential transmission clock signal TMDS_Bit_Clock_Ratio and a scrambling enable value Scrambling_Enable in the 0x20 register of the SOC and the device.
S1704, SOC reads TMDS_Bit_Clock_Ratio and Scrambling_Enable.

Since the second switch does not include SwitchTX and SwitchRX, SwitchRX is still required to send an SCDC interaction trigger signal to the CEC device. The second switching circuit can directly switch the communication link to an HDMI extension interface corresponding to a first interface number, that is, directly create a communication link between the SOC and the CEC device, thereby passing through SwitchTX and SwitchRX of the first switching circuit. There is no need for two-level interaction when the display device interacts with the CEC device for SCDC. And this process only requires the registers of the SOC and the device to read and write data, without the need to use the registers of the SOC and SwitchTX and the registers of the SwitchRX and the device to read and write data.
S1705, SOC writes a status scrambling value Scrambling_status to the 0x21 register of the SOC and device.
S1706, The CEC device reads Scrambling_status.

After receiving the SCDC interaction trigger signal sent by SwitchRX, the CEC device first needs to write the values of TMDS_Bit_Clock_Ratio and Scrambling_Enable to the 0x20 register of the SOC and the device. The SOC can directly read the values of TMDS_Bit_Clock_Ratio and Scrambling_Enable from the 0x20 register of the SOC and the device. Then the SOC can directly write the Scrambling_status value to the 0x21 register of the SOC and the device. The CEC device can directly read the Scrambling_status value from the 0x21 register of the SOC and the device, and then determine whether the display device supports the SCDC function based on the Scrambling_status value.
S1707, The SOC detects whether the audio and video signals are stable and whether the audio and video decoding is successful.
S1708, The CEC device writes a value indicating whether there is an abnormality into the 0x40/0x41 register of the SOC and the device.
S1709, The CEC device reads the register 0x40/0x41 and determines whether there is an abnormality in the interaction based on the written value.

After determining that the display device supports the SCDC function, the CEC device can obtain the detection value from the SOC to determine whether there is an abnormality in the signal interaction between the CEC device and the display device. Specifically, if the SOC recognizes that the audio and video signals are stable and the audio and video decoding is successful, a value indicating no abnormality is written into the 0x40/0x41 register of the SOC and the device. Finally, the CEC device can read the value indicating no abnormality from the 0x40/0x41 register of the SOC and the device, and judge that there is no abnormality in the signal interaction between the CEC device and the display device based on the value indicating no abnormality, and the CEC device can continue to input the audio and video signals to the display device.

If the SOC recognizes that the audio and video signals are unstable or the audio and video decoding is unsuccessful, a value indicating the abnormality is written into the 0x40/0x41 register of the SOC and the device. Finally, the CEC device can read the value indicating the abnormality from the 0x40/0x41 register of the SOC and the device, and judge that there is an abnormality in the signal interaction between the CEC device and the display device according to the value indicating the abnormality, and the CEC device can stop inputting the audio and video signals to the display device.

The second switching circuit directly switches the communication link to the HDMI extension interface corresponding to the first interface number, which means that the second switching circuit can directly switch an SCL (Serial Clock) line of the SOC HDMIrx to an SCL line of a corresponding signal source interface through the first switching circuit, and can also directly switch an SDA (Serial Data) line of the SOC HDMIrx to an SCL line of a corresponding signal source interface through the first switching circuit. For example, as shown in FIG. 9, if the extension interface connected to the CEC device is identified as an HDMI3 interface, the second switching circuit can switch the SCL line of the SOC HDMIrx to the SCL line of the extension interface HDMI3, and at the same time, the second switching circuit can switch the SDA line of the SOC HDMIrx to the SDA line of the extension interface HDMI3, thereby realizing the creation of a communication link between the display device and the CEC device. Similarly, if it is recognized that the extension interface connected to the CEC device is the HDMI4 interface, the second switching circuit can switch the SCL line of the SOC HDMIrx to the SCL line of the extension interface HDMI4 interface, and at the same time, the second switching circuit can switch the SDA line of the SOC HDMIrx to the SDA line of the extension interface HDMI4 interface, thereby realizing the creation of a communication link between the display device and the CEC device.

From the above content, it can be seen that in the device control method provided by the embodiments of the present disclosure, when the CEC device is connected to the display device through the HDMI extension interface, an SCDC interaction trigger signal can be sent to the CEC device through the SwitchRX of the first switching circuit. The CEC device feeds back SCDC interaction information according to the SCDC interaction trigger signal, identifies the first interface number of the HDMI extension interface to which the CEC device is connected, and then sends the first interface number to the second switching circuit. The second switching circuit switches the communication link to the HDMI extension interface corresponding to the first interface number. If the CEC device determines that the display device supports the SCDC function based on the SCDC interaction information, the display device can perform SCDC interaction with the CEC device based on the communication link.

In this way, the communication link between the display device and the CEC device can be directly established by using the second switching circuit. Since the second switching circuit does not include SwitchTX and SwitchRX, there is no need for two-level SCDC interaction between the display device and the CEC device, thereby shortening SCDC interaction time.

In addition, as shown in the above-mentioned FIGS. 16 to 17, whether the communication link is established using the first switching circuit or the second switching circuit, the CEC device needs to wait for SwitchRX to output the SCDC interaction trigger signal before it can interact with the display device through SCDC. As shown in the above-mentioned FIG. 11, the SCDC interaction trigger signal is the SwitchRX Hotplug pull-up signal. The generation of the SwitchRX Hotplug pull-up signal needs to wait for the SOC Hotplug pull-up signal. The generation of the SOC Hotplug pull-up signal needs to wait for the SwitchTX 5V signal. Therefore, it takes a long time for the CEC device to access the display device before the CEC device can receive the SCDC trigger signal sent by SwitchRX.

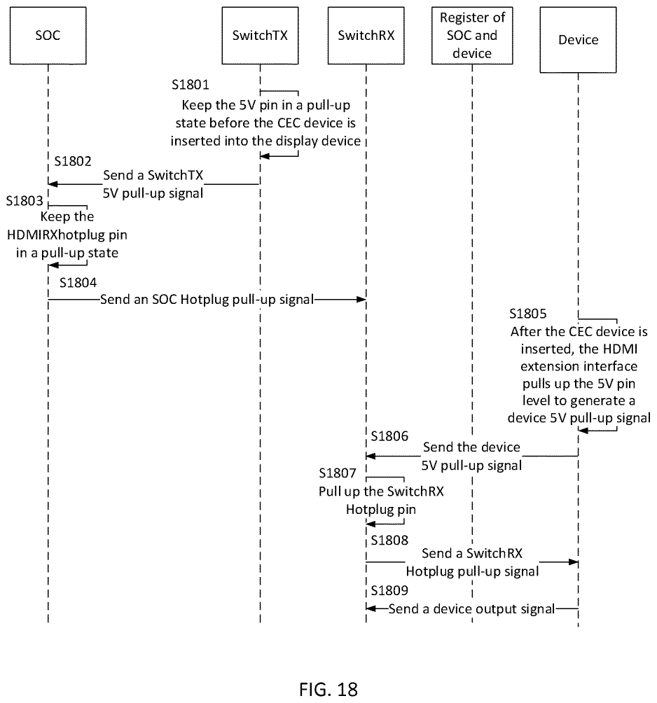

To solve the above problem, the process of sending the SCDC interaction trigger signal to the CEC device through the first switching circuit in the embodiments of the present disclosure can also be shown in FIG. 18, and can include the following steps.
S1801, SwitchTX keeps the 5V pin in a pull-up state before the CEC device is inserted into the display device.
S1802, SwitchTX sends a SwitchTX 5V pull-up signal to the SOC.
S1803, SOC keeps the HDMIRXhotplug pin in a pull-up state.
S1804, SOC sends an SOC Hotplug pull-up signal to SwitchRX.
S1805, After the CEC device is inserted, the HDMI extension interface pulls up the 5V pin level to generate a 5V pull-up signal for the device.
S1806, The CEC device sends the 5V pull-up signal to SwitchRX.
S1807, SwitchRX pulls up the SwitchRX Hotplug pin.
S1808, SwitchRX sends a SwitchRX Hotplug pull-up signal to the CEC device.
S1809, The CEC device sends a device output signal to SwitchRX.

Since the processing of the SOC and the first switching circuit is an asynchronous process, and the first switching circuit remains connected to the SOC, the SwitchTX 5V can be kept in a pull-up state before the CEC device is connected to the display device. If the SwitchTX 5V is kept in a pull-up state, the HDMIR Hotplug pin of the SOC is also kept in a pull-up state. When the CEC device is connected to the display device, when SwitchRX detects the device 5V pull-up signal, SwitchRX can directly pull up the SwitchRX Hotplug without waiting for the SwitchTX 5V pull-up signal and the SOC Hotplug pull-up signal. Then a SwitchRX Hotplug pull-up signal is generated, and the SwitchRX Hotplug pull-up signal is sent to the CEC device. This shortens the time from when the CEC device is connected to the display device to when the SCDC interaction trigger signal sent by SwitchRX is received, which can further shorten the SCDC interaction time between the display device and the CEC device.

As mentioned above, EDID contains some information about the display device, such as manufacturer information of the display device, supported display resolution, supported sound format, and sound channels, etc. External devices can read EDID data to determine the features supported by the display device.

According to the EDID data, the external device can generate a corresponding media resource signal and send the signal to the display device for playback. However, when the external device parses the EDID data, some content can be parsed abnormally. In this case, the external device will generate an abnormal media resource signal and send the abnormal media resource signal to the display device, causing the display device to display an abnormal signal, and the user will not be able to watch the normal content, giving the user a poor user experience.

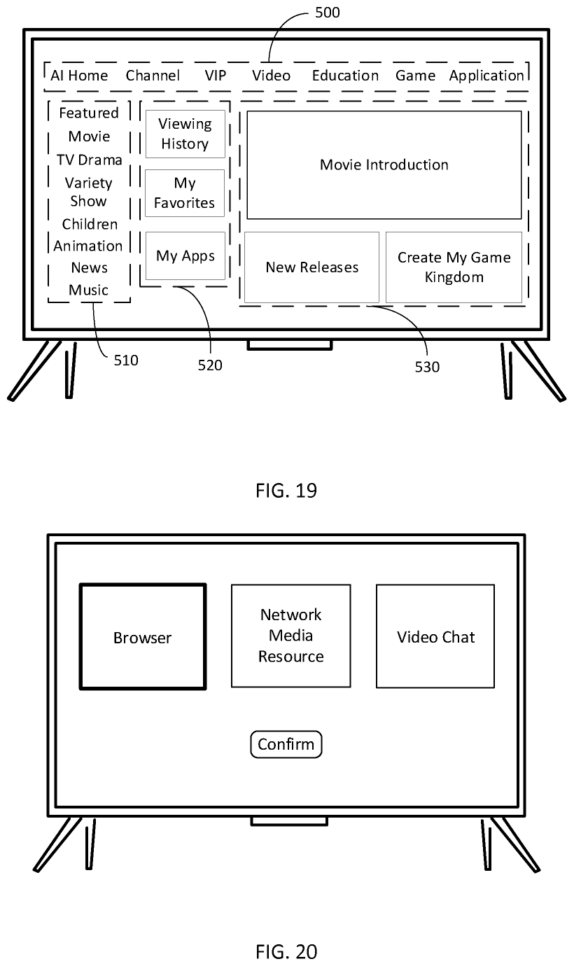

Specifically, when the user controls the display device to turn on, the display device can display a user interface through the display. The user interface can be a specific target image, such as various media resources obtained from a network signal source, including videos, pictures and other content. The user interface can also be some UI interfaces of the display device. FIG. 19 is a schematic diagram of the user interface according to some embodiments. As shown in FIG. 19, the user interface can include a first navigation bar 500, a second navigation bar 510, a function bar 520 and a content display area 530, and the function bar 520 includes multiple function controls such as “watch history”, “my favorites” and “my apps”.

The user can view the applications that have been installed on the display device, that is, the functions supported by the display device, through the application panel. It should be noted that the application installed on the display device can be a system application or a third-party application. The user controls the display device to implement the corresponding functions of the application by opening a certain application. FIG. 20 is a schematic diagram of the application panel according to some embodiments. As shown in FIG. 20, the application panel can include three controls: “browser”, “network media resource” and “video chat”. The user can control the display device to open the browser application by clicking the “browser” control. The user can perform corresponding operations in the browser, such as searching for media resource. The user can click the “network media” control to use the display device to watch some network media resource channels, including various media resources provided on the network. The user can click the “video chat” control to use the display device for video chat.

As mentioned above, the display device is provided with a device interface for connecting an external device, and the external device can be a media resource device, such as a gaming device. The device interface refers to an HDMI interface, including the HDMI extension interface and HDMI native interface mentioned above.

The display device and the external device that establish a communication connection serve as a receiving end (Sink end) and a sending end (Source end) respectively. The external device can perform a data transmission process with the display device through the device interface, and send a media resource signal to the display device. For example, when a user uses a gaming device, video data and audio data can be output in real time for the gaming process, and the video data and audio data can be sent to the display device so that the video data and audio data can be output as images and sounds through the display device. At this time, the gaming device serves as the sending end, and the display device serves as the receiving end.

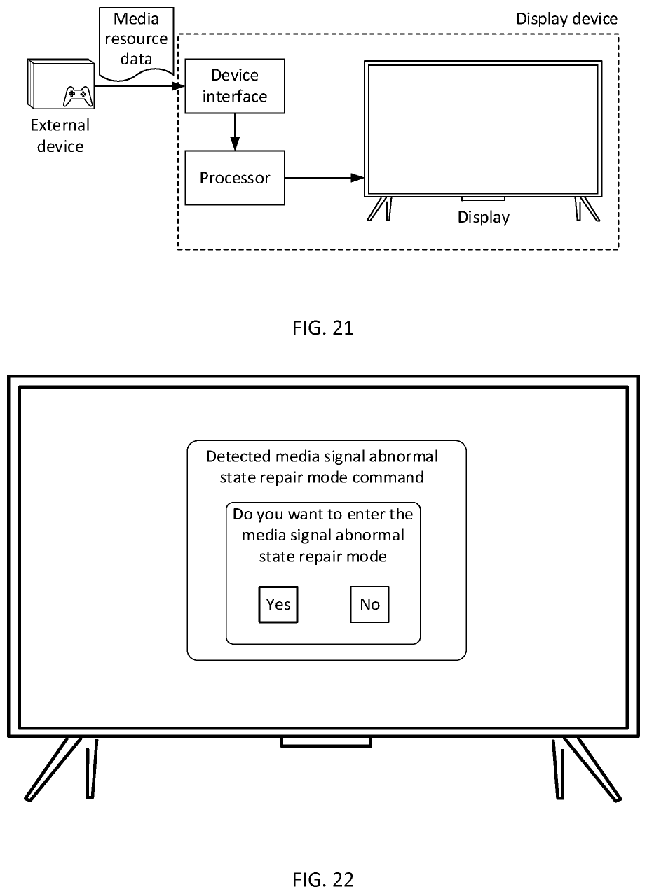

The display device and the external device are provided with data interfaces with the same interface specification and function. FIG. 21 is a schematic diagram of the connection between the display device and the external device according to some embodiments. As shown in FIG. 21, the display device and the external device are provided with device interfaces: HDMI interfaces. The user can plug two ends of a data cable of the HDMI interface into the display device and the external device respectively, and after starting the external device and the display device, set the signal source of the display device to the HDMI interface, thereby realizing data transmission between the display device and the external device. In order to realize the communication connection between the display device and the external device, other connection methods can also be used between the display device and the external device, such as digital visual interface (DVI), video graphics array (VGA), universal serial bus (USB), etc. It can also be a wireless connection method, such as WLAN, Bluetooth connection, infrared connection, etc. Different communication connection methods can use different information transmission protocols. For example, when the HDMI interface is used for the connection, the HDMI transmission protocol can be used for data transmission. After the display device and the media resource device are connected through HDMI, the media resource device can send a media resource signal to at least one processor of the display device. At least one processor can decode the media resource signal to obtain video data and audio data. The display device can display video data on the display and play audio data through the speaker. After the connection relationship is established between the display device and the external device, the data transmission between the display device and the external device can be bidirectional, that is, the external device can send media data and other data related to audio and video output to the display device; at the same time, the display device can also send data to the external device, such as sending request data, feedback result data, etc. Therefore, in addition to transmitting media data to complete the playback process, the display device and the external device can also realize interactive control by transmitting control instructions.

When it is detected that an external device is connected to the external device interface, in order to exchange data with the external device, the display device can generate extended display identification data EDID and notify the external device to read the EDID information. After reading the EDID information, the external device can generate corresponding media data and send the corresponding media data to the display device. It should be noted that the EDID information mainly defines supported image resolution, supported sound format, sound channel and 3D information supported by the display device. Its purpose is to tell the external device the features supported by the display device, so that the external device can output the audio and video data supported by the display device according to these features. Otherwise, the audio and video data output by the external device is not supported by the display device, and the display device cannot play the audio and video data normally. According to the EDID data, the external device can generate corresponding media data and send the corresponding media data to the display device for playback.

It should be noted that the external device needs to fully parse the EDID to determine all the capability information supported by the display device, so as to generate the media resource signal that the display device can play. However, when the external device parses the EDID data, some content can be parsed abnormally. In this case, the external device will generate and output abnormal media resource signals. This can include the following situations:
the number of EDID bytes that the external device can read is different from the total number of EDID bytes, that is, the external device cannot read all the EDID content, and thus outputs abnormal media resource signals.

There are multiple versions of the HDMI interface transmission protocol, such as HDMI1.4, HDMI2.0, etc. Some external devices, such as DVD, are devices that support HDMI1.4 and do not recognize the fields under HDMI2.0. If the display device uses the EDID corresponding to the HDMI2.0 version, some external devices cannot parse it, resulting in the output of DVI signals but no audio signals.

Display devices can support a variety of functions, such as 3D display, so relevant instructions will be written in EDID. However, for external devices that do not support the same function, the byte content corresponding to the instructions may not be parsed, resulting in the output of abnormal media resource signals.

EDID will declare the video parameters supported by the display device, including resolution and frame rate, etc. However, the EDID can be configured with incorrect parameters, resulting in the external device being unable to recognize the parameters, making the output signal non-standard and abnormal.

There is a check bit in each field of EDID. If the check bit is configured incorrectly, the external device will consider the EDID illegal and output a DVI signal.

When the external device parses the EDID abnormally, it will not inform the display device of the abnormal content parsing, but directly output the abnormal signal to the display device. The display device cannot confirm the reason why the external device outputs the abnormal signal, and will display the abnormal signal. The user cannot watch the normal content, which gives the user a poor user experience.

To solve the above problems, the display device of the embodiments of the present disclosure can have a function of repairing an abnormal state of a media resource signal, and can be able to repair abnormal media resource signals. The display device can be provided with an abnormal state repair mode of a media resource signal. After the external device reads the EDID of the display device, if the analysis is abnormal, an information frame representing the analysis result can be generated and sent to the display device. Based on the information frame, the display device may determine the reason of the abnormal media resource signal and perform repairs. This ensures that the external device sends a normal media resource signal, thereby ensuring that the user can watch normal media content and improving the user experience.

In some embodiments, the user can send an instruction of an abnormal state repair mode of a media resource signal to the display device by operating a designated button of the remote control. In the actual application process, the correspondence between the instruction of the abnormal state repair mode of the media resource signal and the button of the remote control is pre-bound. For example, a button of the abnormal state repair mode of the media resource signal is set on the remote control. When the user presses the button, the remote control sends the instruction of the abnormal state repair mode of the media resource signal to the display device. At this time, at least one processor of the display device can control the display device to enter the abnormal state repair mode of the media resource signal. In addition, an option of the abnormal state repair mode of the media resource signal can also be set in the system UI interface of the display device. When the user clicks the option, the display device can be controlled to enter or exit the abnormal state repair mode of the media resource signal.

In some embodiments, in order to prevent the user from accidentally triggering the abnormal state repair mode of the media resource signal, when receiving the instruction of the abnormal state repair mode of the media resource signal, the display device can display confirmation information of the abnormal state repair mode of the media resource signal through the display as shown in FIG. 22, so that the user can perform a second confirmation of whether to enter the abnormal state repair mode of the media resource signal.

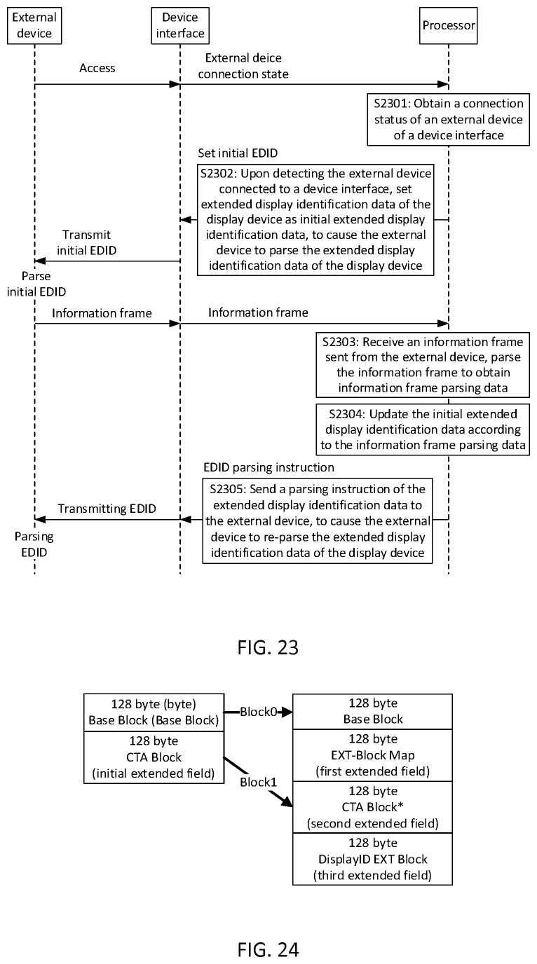

FIG. 23 is a flow chart of various components in a display device repairing an abnormal state of a media resource signal according to some embodiments, which can include the following steps.
S2301, Obtaining a connection status of an external device of a device interface.
S2302, Upon detecting the external device connected to a device interface, setting extended display identification data of the display device as initial extended display identification data, to enable the external device to parse the extended display identification data of the display device.
S2303, Receiving an information frame sent from the external device, parsing the information frame to obtain information frame parsing data; wherein the information frame represents a parsing result of the extended display identification data by the external device when the extended display identification data cannot be parsed normally.
S2304, Updating the initial extended display identification data according to the information frame parsing data.
S2305, Sending a parsing instruction of the extended display identification data to the external device, to enable the external device to re-parse the extended display identification data of the display device.

In some embodiments, the display device can obtain the connection status of the external device of the device interface to detect whether the external device is connected to the display device.

The display device can detect each device interface in real time to determine whether the device interface is connected to an external device. The display device can obtain the device connection status of the device interface through a device insertion detection thread.

The common HDMI interface currently includes 4 TMDS channels for transmitting data, and 1 display data channel (DDC) and consumer electronics control (CEC) line. HDMI also includes a hot plug detect (HPD) pin, and the display device can detect whether an external device is connected to the HDMI interface through HPD. When an external device is connected to the HDMI interface, a 5V voltage can be provided to the HPD. Therefore, it is possible to determine whether an external device is connected to the device interface by detecting whether the voltage at the device interface is 5V.

In some embodiments, after detecting that the device interface is connected to an external device, at least one processor can set the extended display identification data EDID of the display device, so that the external device can read and parse the extended display identification data of the display device to output a media resource signal to the display device. The extended display identification data can include multiple types, such as a 256-byte EDID and a 512-byte EDID. At least one processor can set the extended display identification data of the display device as the initial extended display identification data. The initial extended display identification data can be a pre-set EDID, which can be 256 bytes or 512 bytes, which is not limited in the embodiments of the present disclosure. For example, the display device can use a 256-byte EDID to declare relevant parameter information of the display device. The 256-byte EDID includes two fields, namely a base field Base Block and an initial extension field CTA Block, each of which is 128 bytes.

Here, the base field can include device information of the display device, and the device information can include data such as ID and manufacturer information of the display device. The base field can also include information such as video parameters of the display device. The video parameters are related parameters when the display device plays the video, such as a display resolution and color parameters supported by the display. The base field includes 128 bytes. Here, 00H-07H bytes represent a file header of the EDID data and are also a starting mark of the base field. These 8 bytes are fixed and equal to 0x00FFFFFFFFFFFFFF00.
08H-09H bytes represent the manufacturer's ID or name.
0AH-0BH bytes represent product ID.
0CH-0FH bytes represent a production sequence number.
10H-11H bytes represent a production time.
12H-13H bytes represent a version number, for example, 1.3 is represented by 01, 03.
14H bytes represent a video input signal type, whether it is digital signal or analog signal.
15H bytes represent a maximum horizontal size.
16H bytes represent a maximum vertical size.
17H bytes represent a display transmission feature, that is, a display Gamma version, such as 2.20.
18 bytes represent HDPMS and supported attributes, such as the display type being RGB.
19H-22H bytes represent chrominance information.
23H bytes represent a supported basic timing table 1, such as 640×480@60 HZ (IBM, VGA), 800x600@60 HZ (VESA).
24H bytes represent a supported basic timing table 2, such as 1024×768@60 HZ (VESA).
25H bytes represent timing information reserved by the manufacturer.
26H-35H bytes represent a supported standard timing table.
36H-47H bytes represent detailed description 1 of the timing. This field is a more detailed description of the timing, such as horizontal and vertical image size, refresh mode being interlaced or progressive, etc.
48H-59H bytes represent detailed description 2 of the timing.
5AH-6BH bytes represent detailed description 3 of the timing.
6CH-7DH bytes represent detailed description 4 of the timing. These four fields are used to describe detailed information of different timings. Description 1 must be present, and the others can be empty.
7EH bytes represent a flag bit of an extension part. If it is 0, there is no extension part. If it is 1, there is still an extension part behind.
7FH bytes represent a CheckSum check bit, which is used to check whether the data has been illegally modified or whether there is a transmission error. It is an end mark of the base field.

The base field has only 128 bytes and can store limited information. Some other parameter information of the display device can be declared through an initial extension field.

The initial extension field can include audio playback parameters and mode information of the display device. The mode information refers to video and audio modes, such as analog or digital. The audio playback parameters are relevant parameters when the display device plays audio, which can include an audio sampling rate, audio sampling depth, and audio format information. The display device can also obtain some other extended information, such as manufacturer information. The initial extension field can be a CTA Block. The original name of CTA is CEA (Consumer Electronics Association of the United States). The initial extension field can be a CEA-861D extension block. The initial extension field includes 128 bytes. It includes the following extended information:
image and sound mode, such as analog or digital; color mode, such as YCbCr (4:4:4), YCbCr (4:2:2); a brief timing description, which specifies some timing information not described in field 1, such as 640x480p@60 HZ 4:3, etc; a brief description of the sound, such as PCM (2 channels, 32 KHZ, 44.1 HZ, 48 HZ, 16 bit, 20 bit, 24 bit), AC-3, Dolby Digital+ (6 channels, 32 KHZ, 44.1 KHZ, 48 KHZ, maximum bit rate 640 kbps), speakers (left and right channels); VSDB: Manufacturer-specific information, such as CEC physical address, 3D information, deep color information, etc.; CheckSum check bit.

By appending the initial extension field after the base field, a 256-byte EDID can be obtained.

It should be noted that the 256-byte EDID can only store limited information, resulting in limited display device parameter information that can be declared. For some capability information supported by the display, such as some display resolutions, game optimization related function parameters, such as variable refresh rate (VRR), etc., 512-byte EDID can be used for declaration.

The 512-byte EDID can include four 128-byte fields, namely a base field, a first extended field, a second extended field, and a third extended field. The base field is used to declare device information of the display device, which is the same as the base field in the 256-byte EDID, namely the Base Block. The first extended field can be an EXT-Block Map, the second extended field can be a CTA Block, and the third extended field can be a DisplayID EXT Block.

Here, the first extended field represents the order of all extended fields in EDID, and the order is: the first extended field, the second extended field, the third extended field. The second extended field can be obtained by modifying the initial extension field. Some functional parameters of the display device, such as VRR functional parameters, FreeSync functional parameters, and Dolby Vision functional parameters, can be written into the initial extension field to obtain the first extended field. The third extended field can include some parameter information of the display device, including other resolution parameters between the maximum resolution that can be declared in the aforementioned field and the maximum resolution supported by the display device, such as physical resolution parameters of the display.

FIG. 24 is a schematic diagram of a 256-byte EDID and a 512-byte EDID according to some embodiments. As shown in FIG. 24, the 256-byte EDID includes a base field Base Block and an initial extension field CTA Block. The base field does not need to be changed, and a first extension field EXT-Block Map is generated and inserted between the base field and the initial extension field. After modifying the initial extension field, a second extension field CTA Block* is obtained. At the same time, a third extension field DisplayID EXT Block is generated, and a 512-byte EDID is obtained after the second extension field. In addition to 512-byte EDID and 256-byte EDID, other EDIDs can also be used in display devices, such as 128-byte EDID and 384-byte EDID, which is not limited in the embodiments of the present disclosure.

In some embodiments, the display device can store the initial extended display identification data in a preset storage module, and the preset storage module can be a register RAM. The display device can send an instruction to an external device so that the external device reads the extended display identification data of the display device. The external device can read and parse the initial extended display identification data through the DDC channel of the HDMI interface, thereby determining relevant parameter information of the display device.

In some embodiments, if the external device can parse the EDID normally, a media resource signal can be generated and sent to the display device. If the external device cannot parse the EDID normally, an information frame can be generated, and the information frame is used to represent the parsing result of the external device on the extended display identification data, such as unrecognizable EDID content. The external device can send the information frame to the display device. In response to the information frame sent by the external device, the display device can mark the external device as an abnormal state of the media resource signal. The display device can parse the information frame to obtain the information frame parsed data. It should be noted that the format declaration of the information frame, such as what kind of data the information frame includes, what format the data is, and what meaning each block of data represents, can be pre-stored in the display device. After parsing the information frame, the display device can determine the parsing result of the external device on the extended display identification data.

In some embodiments, when the external device cannot completely parse the EDID, an information frame can be generated according to the parsing result, and the information frame can include a statement of the external device on the content that cannot be parsed when parsing the EDID.

The information frame includes a packet header and packet content. The packet header can define an information frame type and a version of the information frame, and a length of information frame data. The packet content can define the location analysis of the external device, including EDID content that the external device cannot recognize.

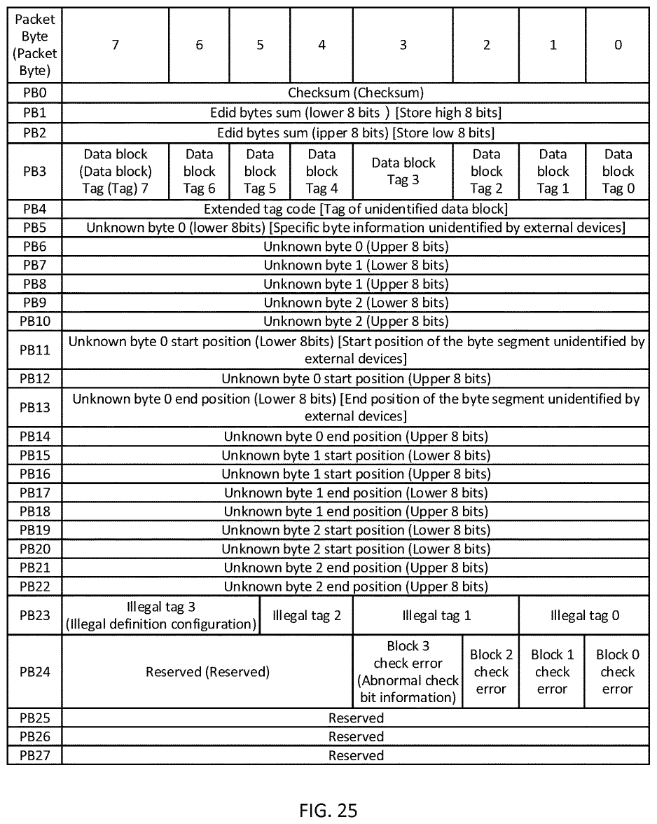

FIG. 25 is a schematic diagram of frame data of an information frame according to some embodiments. As shown in FIG. 25, the frame data includes multiple bytes of data, which are respectively used to declare different information.

PB0 is a fixed check bit, which is used to indicate a checksum value.

The number of bytes of EDID read by the external device is set in PB1 and PB2, where PB2 stores the upper 8 bits and PB1 stores the lower 8 bits. When the external device cannot completely parse the EDID content, it may not be able to read all the EDID content, resulting in the number of bytes read being different from the total number of bytes of EDID of the display device. At this time, the data generated in PB1 and PB2 is different from the total number of bytes of EDID. In the embodiments of the present disclosure, the data in PB1 and PB2 is referred to as the first number, so the first number is used to represent the number of bytes that can be read when the external device parses the extended display identification data.

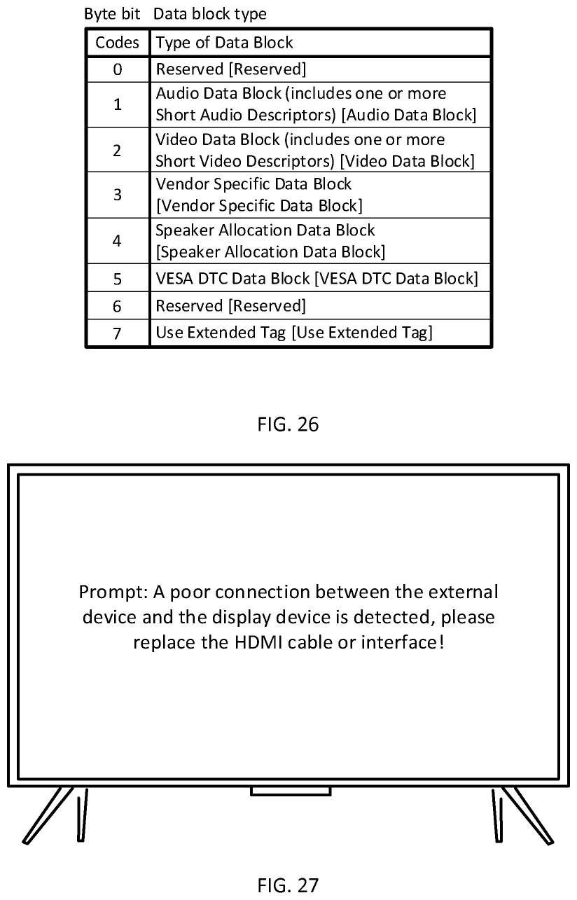

The information of the data block (Data Block) that the external device cannot recognize is set in PB3 and PB4. In the EDID of the display device, each field can include multiple data blocks. When the external device parses the EDID, it may not be able to parse a certain data block. In this way, relevant information can be written in PB3 and PB4. Here, PB3 can include bit7-bit0, a total of 8 bytes, and each byte may represent a type of data block. If the external device cannot parse a certain type of data block, the information of the corresponding byte can be set to 1. If a certain type of data block can be parsed, the information of the corresponding byte can be set to 0. Therefore, by the data of a certain byte in PB3 being 1, it can be determined that the data block corresponding to the byte is in a state that is not recognized by the external device. FIG. 26 is a schematic diagram of the data block type corresponding to each byte of PB3 according to some embodiments. As shown in FIG. 26, PB3 includes 8 byte bits 0-7, and the data block types corresponding to each byte bit are: Reserved, Audio Data Block, Video Data Block, Vendor Specific Data Block, Speaker Allocation Data Block, VESA DTC Data Block, Reserved and Use Extended Tag.

Meanwhile, PB4 represents a specific tag of an unidentified data block, which is used to indicate an unidentified data block. For example, if the external device cannot recognize an extended tag, the byte 7 in PB3 is set to 1, and tag information of the extended tag data block is set in PB4.

In the embodiments of the present disclosure, the data in PB3 and PB4 are referred to as first unidentified information. Therefore, the first unidentified information is used to represent the unidentified data block of the external device parsing the extended display identification data.

The specific byte information that the external device cannot recognize is set in PB5-PB10. The external device can not recognize a certain byte of a certain field of EDID, and the relevant information can be written into PB5-PB10. The value in each of the two bytes can represent the specific byte of EDID that is not recognized. For example, PB5 and PB6 represent the information of 1 unidentified byte, such as Unknown byte 0 in FIG. 25, PB5 represents the low 8 bits of the byte, and PB6 represents the high 8 bits of the byte. PB7 and PB8 represent the information of 1 unidentified byte, such as Unknown byte 1 in FIG. 25. PB9 and PB10 represent the information of 1 unidentified byte, such as Unknown byte 2 in FIG. 25.

In the embodiments of the present disclosure, the data in PB5-PB10 is referred to as the first unidentified information. Therefore, second unidentified information is used to represent unidentified bytes.

PB11-PB22 is set with byte segments that cannot be recognized by the external device, which are called unidentified segments in the embodiments of the present disclosure. An unidentified segment is a segment composed of multiple consecutive bytes. For example, if the external device cannot recognize 100-120 bytes, this part of bytes is an unidentified segment. Every four bytes can be used to represent an unidentified segment. For example, in FIG. 25, PB11-PB14 are used to store start and end positions of a first unidentified segment. PB11 is low 8-bit information of a start byte. PB12 is high 8-bit information of the start byte. PB13 is low 8-bit information of an end byte. PB14 is high 8-bit information of the end byte. PB15-PB18 are start and end positions of a second abnormal segment. PB19-PB22 are start and end positions of a third abnormal segment.

In the embodiments of the present disclosure, the data in PB11-PB22 is referred to as third unidentified information. Therefore, the third unidentified information is used to represent the unidentified segment, including a plurality of consecutive bytes.

PB23 is set with configuration information of illegal definitions found during the external device parsing EDID, which is called unidentified configuration information in the embodiments of the present disclosure. The configuration information of EDID can include function information and parameter information. PB23 is set with four bytes, each of which can represent one found illegal definition configuration illegal tag. Based on this information, the data block with problems in EDID can be determined.

In the embodiments of the present disclosure, the data in PB23 is referred to as fourth unidentified information. Therefore, the fourth unidentified information is used to represent unidentified configuration information.

PB24 is set with check bit information with the abnormality detected by the external device. There is a check bit in each field of EDID. After parsing each field of EDID, the external device will detect and calculate a check bit value of each field by itself, and then compare the check bit value with a check bit declared in EDID. If the two are different, the external device determines that the check bit information of EDID is abnormal. In PB24, it can mark whether the check bit of each field is abnormal error. Bit0-3 can be used to indicate the abnormality of check bits of four fields.

In the embodiments of the present disclosure, the data in PB24 is referred to as abnormal check bit information. Therefore, the abnormal check bit information is used to represent an abnormal check bit.

The external device can send an information frame to the display device. The display device can parse the information frame to obtain information frame parsing data, and the information frame parsing data can represent a parsing status of the external device to the EDID.

In some embodiments, the display device can update the initial extended display identification data according to the information frame parsing data. At least one processor can send a parsing instruction of extended display identification data to the external device so that the external device re-parses the extended display identification data of the display device, thereby repairing the abnormal state of the media resource signal of the external device.

The display device can first obtain a first number, wherein the first number is used to represent the number of bytes that can be read when the external device parses the extended display identification data.

The display device can obtain the total number of bytes of the initial extended display identification data.

The display device can detect whether the first number and the total number of bytes are the same, thereby determining whether the external device has parsed each byte of the EDID.

If the first number and the total number of bytes are different, it means that the external device cannot parse every byte of the EDI. It can be that a certain byte cannot be parsed, or that all bytes in a certain section cannot be parsed. At this time, the display device can detect the relationship between the first number and the number of field bytes of the initial extended display identification data. It should be noted that each field of EDID has 128 bytes, that is, the number of field bytes is 128.

If the first number is an integer multiple of the number of field bytes, it means that the content that the external device can read is at least one complete field, and there is no situation where a field is not read completely, but one or several fields are not read. It can be that the external device does not read the subsequent fields after obtaining the required data from the previous field. At this time, the display device can send the total number of bytes to the external device, so that the external device re-parses the initial extended display identification data according to the total number of bytes to parse the complete EDID.

If the first number is not an integer multiple of the number of field bytes, it means that the external device cannot fully parse a certain field, and there can be poor signal transmission resulting in missing parsed content. The display device can control the display to display first prompt information to prompt the user to reconnect the external device.

In some embodiments, considering that the external device can not have parsed the EDID at all, after acquiring the first number, the display device can first detect the first number.

If the first number is equal to a preset value, a parsing instruction of extended display identification data is sent to the external device, so that the external device re-parses the extended display identification data of the display device. In the embodiments of the present disclosure, the preset value can be 0. When the first number is 0, it means that the external device has not parsed any byte of the EDID, indicating that the external device has not parsed the EDID at all. It can be due to a timing problem that the external device does not parse the EDID. For example, the external device needs to detect that a device interface pulls up an HPD pin before reading the EDID, but the external device can not detect this process, resulting in the EDID not being parsed. Therefore, the display device can notify the external device to re-read the EDID.

After the external device re-reads the EDID, the external device can send an information frame to the display device again. The display device can perform detection again. If it is detected that the number of bytes that the external device can read (the new first number) is still the preset value, it means that there is a problem with the connection between the external device and the display device. There may be a problem with the connection line, such as poor contact. At this time, the display device can control the display to display first prompt information, and the first prompt information is used to prompt the user to reconnect the external device. FIG. 27 is a schematic diagram of the first prompt information according to some embodiments. As shown in FIG. 27, the first prompt information can be “A poor connection between the external device and the display device is detected, please replace the HDMI cable or interface”. If the first number is not equal to the preset value, it means that the external device can parse the EDID, and the display device can execute the step of obtaining the first byte number of the initial extended display identification data.

In some embodiments, if the first number and the first byte number are the same, the display device can continue to obtain the first unidentified information to detect abnormal parsing of the external device. The first unidentified information is used to represent an unidentified data block of the extended display identification data parsed by the external device.

The display device can obtain a data block type of the unidentified data block. If the data block type is a preset type, the extended display identification data of the display device is updated to first extended display identification data. A protocol version number of the first extended display identification data is lower than a protocol version number of the initial extended display identification data. In the embodiments of the present disclosure, the preset type can be HF-VSDB. The inability to identify HF-VSDB indicates that the external device only supports the HDMI1.4 protocol. At this time, EDID can correspond to a higher version of the HDMI protocol, such as HDMI2.0. Therefore, the display device can lower the version of EDID1, for example, switching to the EDID of the HDMI1.4 protocol.

If the data block type is not a preset type, the unidentified data block is deleted from the initial extended display identification data to update the initial extended display identification data.

When the data block type is an audio field such as ADB (sound)/HDR/VSVDB (Dolby), the display device can also control the display to display prompt information to prompt the user that the external device does not support these types of audio output.

The display device can send a parsing instruction of extended display identification data to the external device to notify the external device to re-parse the extended display identification data of the display device.

In some embodiments, if the unidentified data block is not detected, the display device can continue to obtain second unidentified information to detect abnormal parsing of the external device, where the second unidentified information is used to represent a certain unidentified byte.

The display device can first detect the meaning of the unidentified byte. If the unidentified byte is a video parameter, a replacement parameter is obtained based on a preset video parameter database, and the unidentified byte in the initial extended display identification data is updated to the replacement parameter. It can be that the declaration method of the video parameter in the EDID cannot be read clearly by the external device. Therefore, a different declaration method can be used to obtain definition information with the same meaning as the original parameter from the video parameter database and replace the original parameter. If there is no replacement parameter, the unidentified byte is directly deleted.

If the unidentified byte is an audio parameter, then when the audio parameter is an audio format, the unidentified byte is deleted from the initial extended display identification data; when the audio parameter is not an audio format, the unidentified byte in the initial extended display identification data is updated to an audio replacement parameter, and a capability value of the audio replacement parameter is lower than the audio parameter. When the audio parameter is an audio format, it means that the external device does not support this audio format and needs to be deleted directly. The audio parameter is not an audio format, but can be an audio capability value, such as the number of channels, sampling rate, and sampling bit number. At this time, the original parameter can be replaced, for example, by using a capability reduction method (reducing the number of channels, sampling rate, and sampling bit number step by step) to modify the audio capability value until the external device can recognize it after reading it. If the unidentified byte is not a video parameter or an audio parameter, the unidentified byte is deleted from the initial extended display identification data.

After modifying the EDID, the display device can send a parsing instruction of extended display identification data to the external device, and the external device re-parses the new EDID. In some embodiments, if no unidentified byte is detected, the display device can continue to obtain third unidentified information to detect abnormal parsing of the external device, and the third unidentified information is used to represent an unidentified segment, and the unidentified segment includes a plurality of consecutive bytes.

The display device can obtain the number of bytes of the unidentified segment. If the number of bytes is an integer multiple of the number 128 of field bytes, it means that the external device just cannot parse one or several complete fields, and the display device can switch the extended display identification data of the display device. For example, if the initial EDID is 512 bytes, it can be switched to 256 bytes of EDID. If the initial EDID is 256 bytes, it can prompt the user that the current external device version is low, and it is recommended to replace the external device.

If the number of bytes is not an integer multiple of the number of field bytes, a target data block corresponding to the first byte of the unidentified segment is obtained. The display device can delete the byte representing the function of the display device in the target data block. Considering that there can be multiple bytes representing functions in the data block, the display device can start from the first byte of the unidentified segment and delete one function byte in turn until the external device can parse the content there. If all the function bytes in the target data block are deleted and the external device still cannot parse it, it can continue to delete the function bytes in the next data block. After modifying the EDID, the display device can send a parsing instruction of extended display identification data to the external device.

In some embodiments, if no unidentified segment is detected, the display device can continue to obtain fourth unidentified information to detect abnormal parsing of the external device. The fourth unidentified information is used to represent unidentified configuration information, and the configuration information can include function information and parameter information.

The display device can obtain standard configuration information of the display device and update the unidentified configuration information in the initial extended display identification data according to the standard configuration information. The unidentified configuration information refers to the situation where the configuration information of the EDID is illegally defined, which can include the following situations.

When the display device configures EDID, if it is not careful when adding functions, the last data block byte will be missing (for example, the data block of block1 is at 248-254, if 5 bytes are added in front of this data block, the content of the last data block byte will be missing). At this time, the external device can configure an illegal tag in PB23 of the information frame to indicate that there is an illegally defined data block. At this time, the display device can check whether the corresponding data block meets the configuration standard (length, content, etc.) according to the standard configuration information. For configuration information that does not meet the standard, the display device can modify the content of these bytes. For example, if the declared length of the data block does not match the actual length, the display device can check whether the unused length reserved by the EDID byte is greater than the missing length of the data block. If it is greater than or equal to the missing length of the data block, the field will be re-filled according to the capability according to the standard configuration information; if it is less than the missing length of the data block, the content of the field will be directly deleted.

When the display device configures EDID, if some parameters, such as resolution and other timing configuration errors (such as 3840*2160P60 hz signal, the receiving end mistakenly configures the height information to 0), it will search for standard configuration information to reconfigure the information. After modifying EDID, the display device can send a parsing instruction of extended display identification data to the external device.

In some embodiments, if the unidentified configuration information is not detected, the display device can continue to obtain abnormal check bit information to detect an abnormal parsing status of the external device, and the abnormal check bit information is used to represent the abnormal check bit.

The display device can obtain an abnormal field corresponding to an abnormal check bit. For example, if the abnormal check bit information indicates that a check bit of the third field of the EDID is abnormal, then the third field is the abnormal field. The display device can recalculate a target check bit of the abnormal field and update the abnormal check bit in the initial extended display identification data to the target check bit. After modifying the EDID, the display device sends a parsing instruction of extended display identification data to the external device.

In some embodiments, in response to a media resource signal sent by the external device when the extended display identification data can be normally parsed, the display device can parse the media resource signal to obtain media resource data.

In some embodiments, the extended display identification data can also include a physical address of a device interface. The external device can read the capability of the display device and the physical address of a currently connected target device interface according to the extended display identification data.

Considering the security of the display device, the display device can detect external devices. For example, the display device can first obtain a physical address of a target device interface, which is referred to as a first physical address in the embodiments of the present disclosure. The display device can send a physical address acquisition instruction to a target external device through the target device interface, so that the target external device feeds back a second physical address according to the physical address acquisition instruction. The target external device can read EDID information of the target device interface and parse out the first physical address of the target device interface. In response to the physical address acquisition instruction, the target external device can send the read physical address to the display device.

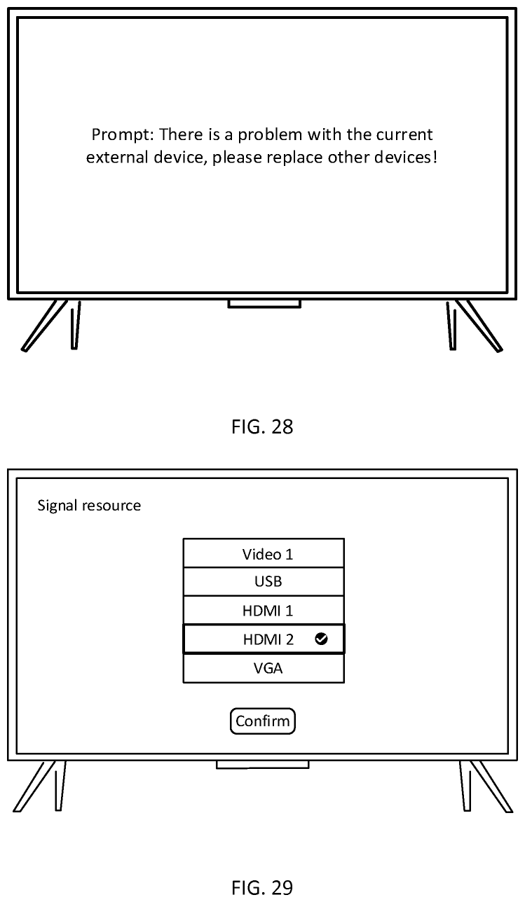

The display device can receive the second physical address sent by the external device, and detect whether the second physical address is the same as the first physical address. If the first physical address and the second physical address are the same, it means that the target external device can read and parse the EDID normally. At this time, the display device can obtain the connection method between the target external device and the target device interface to set a video playback channel. If the first physical address and the second physical address are different, it means that there is a problem with the target external device. It may be that the target external device cannot read the EDID, indicating that there is a security problem with the device, or it may be that the target external device cannot parse the EDID or parses out an error message, indicating that the working performance of the device is poor or there is a problem with the device. In view of this, the device cannot be used normally. The display device can control the display to display second prompt information to prompt the user to replace the external device connected to the target device interface. FIG. 28 is a schematic diagram of the second prompt information according to some embodiments. As shown in FIG. 28, the second prompt information can be “There is a problem with the current external device, please replace other devices.”

In some embodiments, the display device can be provided with at least two device interfaces, so that the display device can be connected to multiple external devices at the same time, such as a gaming device and a set-top box at the same time. The display device may set the playback channel to one of the device interfaces to display the playback content provided by the external device connected to the interface.

The user can also choose to switch the playback channel of the display device. FIG. 29 is a schematic diagram of a signal source interface according to some embodiments. As shown in FIG. 29, the signal source can include video, USB, HDMI1, HDMI2 and VGA, and each signal source corresponds to a device interface. The user can select one of the signal sources to set the device interface corresponding to the signal source as the current playback channel of the display device. For example, the user can set the playback channel of the display device to HDMI 1, so that the display device displays the content provided by the external device connected to HDMI 1.

It should be noted that when a user connects an external device to a device interface, in order to ensure that the content provided by the device is viewed, it is necessary to ensure that the playback channel of the display device is located at the current device interface. Therefore, it can be necessary to manually switch the playback channel, which is rather cumbersome. Taking into account the user experience, the display device can provide an automatic switching function for playback channels. After the external device is connected to the device interface, an electrical signal can be generated at the device interface, and the display device confirms that the external device is connected to the device interface. After detecting that the device interface is connected to an external device, the video playback channel that displays the video content is automatically switched to the device interface, thereby directly displaying the video content provided by the external device and achieving the effect of an incoming call from the external device.

When the external device is an power amplifier device, after the power amplifier device is connected to the device interface, an electrical signal will also be generated at the device interface, causing the display device to switch the video playback channel to the interface. However, the power amplifier device may only use the function of playing the sound of the display device at this time, and does not provide video content to the display device. At this time, no video data is transmitted in the video playback channel, and the display device cannot display the video content, resulting in a black screen and no signal on the display. At this time, the user cannot watch normally, and the user experience is poor.

To solve the above problems, the display device provided by the embodiments of the present disclosure may also have a playback channel adaptive adjustment function, which can automatically adjust the video playback channel of the display device. The display device can be provided with a playback channel adaptive adjustment mode. After detecting that a certain device interface is connected to an external device, the device type of the external device can be first determined to determine whether it is a power amplifier device. If a power amplifier device is connected, it is determined whether the power amplifier device can provide video data based on the connection method between the power amplifier device and the device interface, so as to set whether to switch the video playback channel to the device interface. This ensures that users can watch video content normally and improves the user experience.

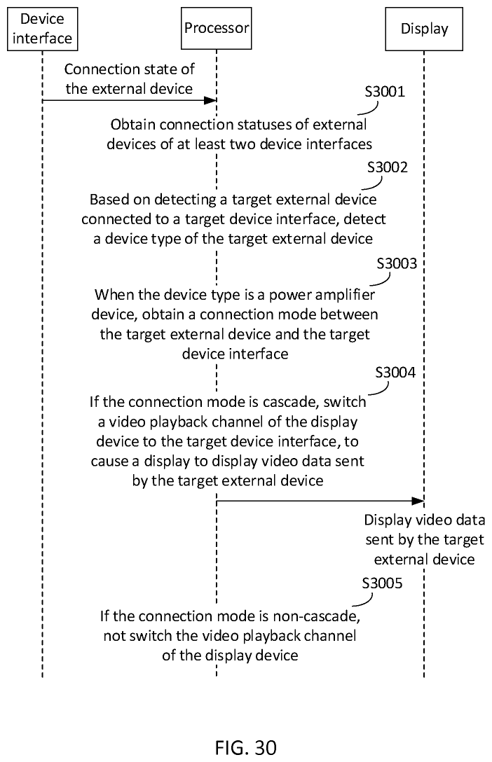

FIG. 30 is a flowchart of various components in a display device performing video playback according to some embodiments, which can include the following steps.
S3001, Obtaining connection statuses of external devices of at least two device interfaces.
S3002, Based on detecting a target external device connected to a target device interface, detecting a device type of the target external device.
S3003, When the device type is a power amplifier device, obtaining a connection mode between the target external device and the target device interface.
S3004, If the connection mode is cascade, switching a video playback channel of the display device to the target device interface, to enable a display to display video data sent by the target external device.
S3005, If the connection mode is non-cascade, not switching the video playback channel of the display device.

In some embodiments, the display device can obtain external device connection statuses of a plurality of device interfaces to detect whether an external device is connected to the display device.

In some embodiments, when it is detected that the target device interface is connected to a target external device, the display device can detect the device type of the target external device.

The device type of the external device can be determined according to the logical address of the external device. A matching relationship is provided between the logical address and the device type of each external device, which is pre-set. Each external device can store the logical address corresponding to its own device type, and the display device also stores the matching relationship between the logical address and the device type. The matching relationship between the logical address and the device type can be in the form of a logical address list, as shown in Table 5.

TABLE 5

| Logical Address | Function |
|---|---|
| 0 | Display Device |
| 1 | Audio Playback 1 |
| 2 | Audio Playback 2 |
| 3 | Tuner 1 |
| 4 | Video playback 1 |
| 5 | Audio Playback Device |
| 6 | Tuner 2 |
| 7 | Tuner 3 |
| 8 | Video playback 2 |
| 9 | Video Recording 1 |
| 10 | Tuner 4 |
| 11 | Video Recording 2 |
| 12 | Reserved |
| 13 | Reserved |
| 14 | Undefined |
| 15 | Undefined |

The logical address of the display device is set to 0, 1-15 represents logical addresses of the external device. For example, the audio playback device can be a power amplifier device, including two logical addresses 1 and 2. The tuner is a media channel playback device, such as a set-top box, including four logical addresses 3, 6, 7, and 10. Video playback is local media playback, which can correspond to a media playback device, including two logical addresses 4 and 8. Video recording can correspond to a video recording device, including two logical addresses 9 and 11.

Therefore, the logical address of the power amplifier device is 5. The display device can detect whether the logical address of the target external device is 5 to confirm whether the target external device is a power amplifier device.

In some embodiments, the display device can send a connection information acquisition request to the target external device through the target device interface. The connection information acquisition request is used to make the target external device feedback connection information according to the connection information acquisition request. The connection information includes the logical address of the target external device.

After receiving the connection information acquisition request, the target external device can obtain its own logical address and generate connection information including the logical address. The external device can send the connection information to the display device.

The display device can receive the connection information fed back by the target external device, and parse the logical address of the target external device from the connection information.

The display device can obtain the device type of the external device based on the logical address. The device type of the target external device can be queried based on the logical address list. If the logical address of the target external device is 5, it is a power amplifier device.

In some embodiments, the display device may inquire whether the target external device is a power amplifier device.

The display device may first obtain the logical address of the power amplifier device, which is referred to as the target logical address in the embodiments of the present disclosure. According to the logical address list, the display device may determine that the logical address of the power amplifier device type is 5.

The display device may generate a power amplifier device response instruction carrying a target logical address and send the instruction to the target external device. The power amplifier device response instruction is used to enable the target external device to feedback reply information when the logical address is the target logical address. For the power amplifier device response instruction sent by the display device, only the power amplifier device can respond to the instruction. The power amplifier device response instruction can be an instruction for pinging the logical address of the power amplifier device.

The target external device can parse the instruction and obtain the target logical address. If the logical address of the target external device is the same as the target logical address, the display device will be replied. If the logical address of the target external device is different from the target logical address, the display device will not be replied.

In response to the reply information sent by the target external device, the display device may determine that the logical address of the target external device is 5, and thus may mark the device type of the target external device as a power amplifier device.

In some embodiments, the power amplifier device has an audio return channel (ARC) function. The audio return channel can return audio data to the power amplifier device through sound return technology for signal amplification processing and output to improve sound quality and other effects and improve user experience. The display device can also be provided with an ARC function to implement the ARC function of the power amplifier device.

The audio return channel can be set in the device interface of the display device, for example, at a certain HDMI interface. When the HDMI interface is connected to the power amplifier device, the display device can set the audio output channel to the audio return channel. The display device can enhance the audio data through the audio return channel function and send the enhanced audio data to the power amplifier device so that the power amplifier device plays the audio data.

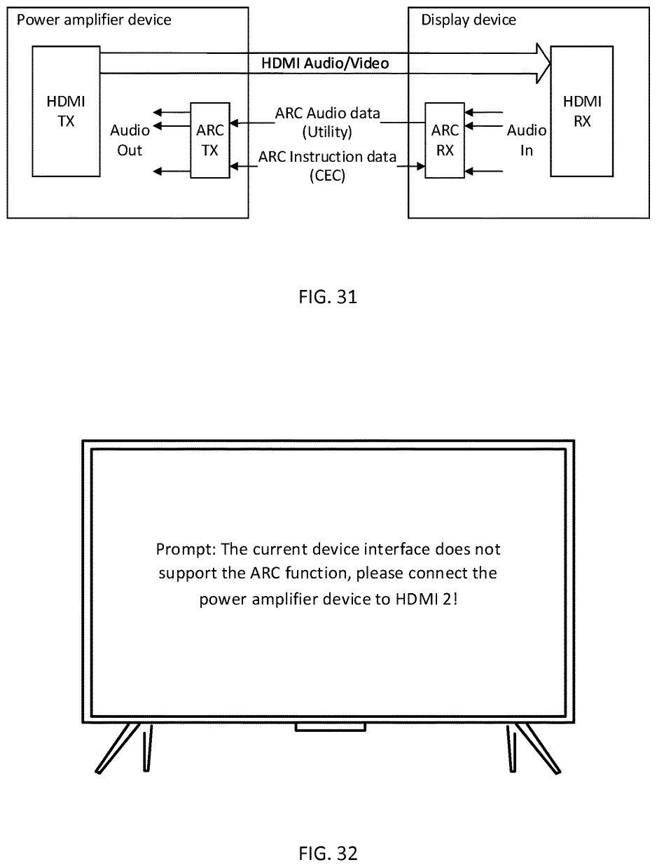

FIG. 31 is a schematic diagram of the hardware connection between the power amplifier device and the display device according to some embodiments. As shown in FIG. 31, the display device and the power amplifier device support the audio return channel function. The sound return is completed using the Utility signal line, while the interactive instructions between the display device and the power amplifier device are completed through the CEC signal line. In this embodiment, the transmission lines of the audio data and the instruction data are completely separated, and time-sharing control by software is not required. Here, the transmission process of the instruction data belongs to a single-wire serial communication, which is called the CEC protocol.

It should be noted that the device interface may or may not be set with the ARC function. If the device interface to which the power amplifier device is connected does not support the ARC function, the function of the power amplifier device cannot be fully utilized. For this reason, the user can be prompted to connect the power amplifier device to a device interface that supports the ARC function.

After detecting that the target external device is an power amplifier device, the display device may obtain function information supported by the target device interface to determine whether the target device interface supports the audio return channel function.

If the target device interface supports the audio return channel function, the display device can obtain the connection mode between the target external device and the target device interface to set the video playback channel.

If the target device interface does not support the audio return channel function, the display device can display target prompt information through the display to prompt the user to switch the device interface to which the target external device is connected. FIG. 32 is a schematic diagram of a display displaying target prompt information according to some embodiments. As shown in FIG. 32, when the target device interface does not support the audio return channel function, the display device can obtain other device interfaces that support the audio return channel function and prompt the user to switch to the interface. For example, the target device interface is an HDMI 1 interface, which does not support the ARC function, but the HDMI 2 interface supports the ARC function. The target prompt information can be “The current device interface does not support the ARC function, please connect the power amplifier device to HDMI 2”.

In some embodiments, when the target external device is a power amplifier device and the target device interface supports the audio return channel function, the display device may further detect whether the power amplifier device can work normally.

In some embodiments, when the device type of the target external device is detected as a power amplifier device, the display device can obtain the connection mode between the target external device and the target device interface. The power amplifier device and the display device can be connected in two ways, including cascade and non-cascade, to provide different functions.

The power amplifier device can perform one-way data exchange with the display device to play the sound of the display device. The audio return channel function can also realize two-way data exchange between external devices and display devices. For example, while the display device sends audio data to the power amplifier device, the power amplifier device can also send video data to the display device.

In cascade mode, the power amplifier device can provide video content to the display device. The power amplifier device is provided with a plurality of interfaces, which can simultaneously connect the display device and other media resource devices. The media resource device can send media data to the power amplifier device. The power amplifier device can parse the media resource device and obtain video data and audio data. The power amplifier device can directly play the audio data and can send the video data to the display device so that the display device displays the video data. At this time, the power amplifier device plays the sound corresponding to the media data and provides the video data to the display device, and the display device can display the video data.

It should be noted that, in addition to the audio data of the media resource data, the display device may also generate some other sounds, such as system sounds, etc. These sounds can be played by the display device itself, or by the power amplifier device.

When all sounds are played by the power amplifier device, the power amplifier device will send video data to the display device, and the display device will also send its own audio data to the power amplifier device, forming a two-way data transmission. When the power amplifier device only plays the audio data in the media data, the display device will not send data to the power amplifier device. At this time, it is only a one-way data transmission of transmitting video data from the power amplifier device to the display device.

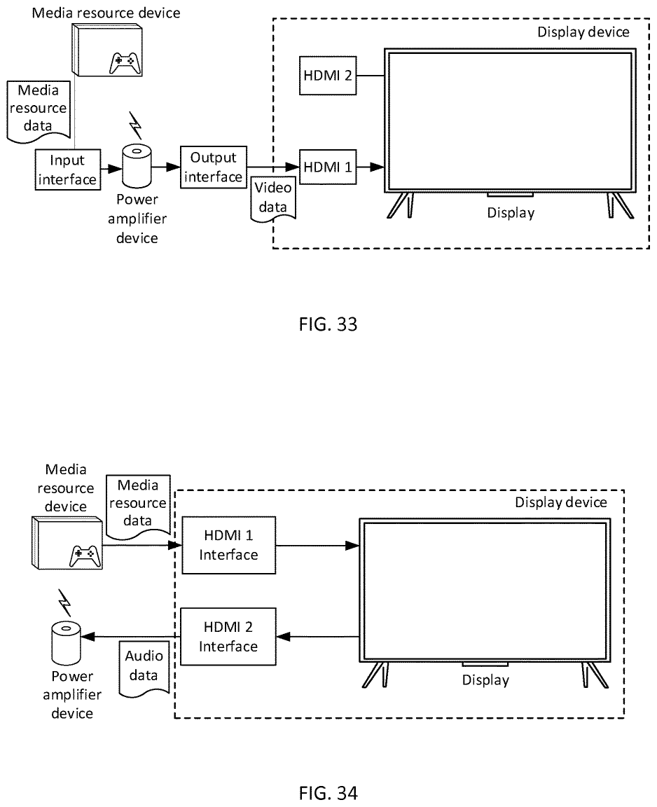

FIG. 33 is a connection diagram of a media resource device, a power amplifier device, and a display device according to some embodiments. As shown in FIG. 33, the display device includes an HDMI 1 interface and an HDMI 2 interface. The power amplifier device includes an input interface and an output interface. The HDMI 1 interface is connected to the output interface of the power amplifier device, and the HDMI 2 interface is not connected to the device. The input interface of the power amplifier device is connected to the media resource device. The media resource device sends the media resource data to the power amplifier device through the input interface of the power amplifier device, and the power amplifier device can decode the media resource data to obtain video data and audio data. Here, the audio data is processed by the power amplifier device itself, so as to directly play the audio data. At the same time, the power amplifier device sends the video data to the display device. The display device can process the video data and display the video data on the display.

In a non-cascaded mode, the power amplifier device is only used to play the audio data provided by the display device. The display device is provided with multiple device interfaces, which can simultaneously connect the media resource device and the power amplifier device. The media resource device can send media data to the display device. The display device can parse the media resource device to obtain video data and audio data. The display device can parse the video data and display the parsed video data on the display. It should be noted that some audio data such as system sound will also be generated in the display device. The display device can send these audio data and the audio data in the media data to the power amplifier device. The power amplifier device can play all the audio data.

In this connection mode, the display device will send the audio data to the power amplifier device, but the power amplifier device will not send the video data to the display device.

FIG. 34 is a connection diagram of a media resource device, a power amplifier device, and a display device according to some embodiments. As shown in FIG. 34, the display device includes an HDMI 1 interface and an HDMI 2 interface. The HDMI 1 interface of the display device is connected to the media resource device, and the HDMI 2 interface is connected to the power amplifier device. The media resource device sends the media data to the display device through the HDMI 1 interface, and the display device can decode the media data to obtain video data and audio data. Here, the video data is processed by the display device itself, so that the video data is directly displayed. At the same time, the display device sends the audio data generated by itself and the decoded audio data to the power amplifier device. The power amplifier device plays all the audio data.

In some embodiments, the display device may detect a connection mode between the target external device and the target device interface.

The display device may send an audio return channel initialization instruction to a target external device.

Since the sound is sent to the power amplifier device by the display device when the non-cascade mode is adopted, the power amplifier device and the display device need to initially interact with each other to ensure that the sound will not be played until the power amplifier device is successfully initialized. In the non-cascade mode, the sound is sent to the power amplifier device by other media resource devices. At this time, when the display device sends an instruction to instruct the power amplifier device to initialize, the power amplifier device will not respond to this instruction.

The power amplifier device responds to a display device instruction, and after initialization, it will feed back an initialization result to the display device. Therefore, the display device can detect whether the power amplifier device feeds back initialization success information.

If the initialization success information fed back by the target external device is not received, the display device may mark the connection mode as cascade. If the initialization success information fed back by the target external device is received, the display device may mark the connection mode as non-cascade.

In some embodiments, if the display device and the power amplifier device are connected in cascade, it means that the power amplifier device will send video data to the display device. The display device can switch the video playback channel of the display device to the target device interface so that the display displays the video data sent by the target external device.

If the connection mode is non-cascade, it means that the power amplifier device will not send video data to the display device. If the video playback channel is switched to the target device interface, no picture will be displayed on the monitor, so the display device does not switch the video playback channel of the display device.

In some embodiments, when the device type of the target external device is not a power amplifier device, it indicates that the target external device will provide video content to the display device. At this time, the video playback channel can be switched to the target device interface to display the content provided by the target external device.

However, considering that some devices are in a standby state, power will also be supplied to the device interface. At this time, if the video playback channel is switched to it, the external device does not actually provide video content, resulting in the display being unable to display the picture.

In this way, the display device may obtain the device status of the target external device.

If the target external device is in a powered-on state, a video playback channel of the display device is switched to a target device interface.

If the target external device is in a standby state, the video playback channel of the display device will not be switched.

In some embodiments, when acquiring the device status of the target external device, the display device may detect a voltage signal of the target device interface.

If the voltage signal carries a transition signal, the display device marks that the target external device is in a powered-on state.

If the voltage signal does not carry a transition signal, the display device marks that the target external device is in a standby state.

In some embodiments, the display device includes an audio output interface for connecting an audio player, such as a speaker, and the audio player can play audio data so that the display device can play sound by itself.

When the target external device is a power amplifier device, and the display device and the target external device are connected in cascade, the power amplifier device will play the audio data of the media resource data. At this time, the system sound generated in the display device can be played by the display device itself. The display device can set the audio playback channel of the display device to the audio output interface, so that the audio player plays the audio data of the display device, and the target external device plays the audio data of the media resource device.

If the display device and the target external device are connected in a non-cascaded mode, the power amplifier device can play the audio data of the display device. At this time, the display device can set the audio playback channel of the display device to the target device interface so that the target external device plays the audio data of the display device.

In some embodiments, the display device can be connected to multiple external devices at the same time, for example, the HDMI interface and the VGA interface are connected to external devices at the same time. The display device needs to set the video playback channel to one of the device interfaces.

The display device can set the playback channel according to a preset priority. For example, the preset priority can be: HDMI>VGA>USB. The display device can detect all device interfaces currently connected to the external device and set the video playback channel according to the priority.

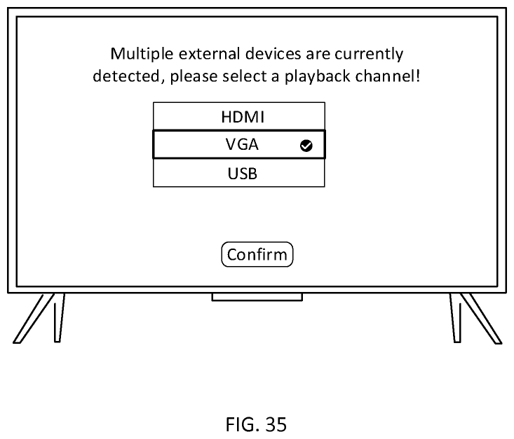

In some embodiments, when it is detected that multiple device interfaces are connected to external devices, the display device can prompt the user to set the playback channel by himself. The display device can detect all device interfaces currently connected to external devices and display a video playback channel setting interface. FIG. 35 is a video playback channel setting interface according to some embodiments. As shown in FIG. 35, the video playback channel setting interface includes all device interfaces currently connected to the external device of the display device. The user can select one of them to be set as the video playback channel of the display device.

Through the above process, the display device of the embodiments of the present disclosure detects the device type of the target external device when the target device interface is connected to the target external device. When the device type is a power amplifier device, the connection method between the target external device and the target device interface is obtained. If the connection method is cascade, the video playback channel is switched to the target device interface to display the video data sent by the target external device. If the connection method is non-cascade, the video playback channel is not switched. By detecting the connection method of the power amplifier device when the external device is a power amplifier device, it is determined whether the power amplifier device will provide video content to the display device, thereby setting whether to switch the video playback channel to ensure that the content is displayed normally on the display to improve the user experience.

What is claimed is:

1. A display device, comprising:
a display;
at least two high definition multimedia interface (HDMI) extension interfaces, wherein the HDMI extension interface is in communication connection with an HDMI native interface via a switching circuit;
wherein the switching circuit comprises a first switching circuit and a second switching circuit; the first switching circuit comprises a transmitting pin and a receiving pin, and the receiving pin is configured to send a Status and Control data channel (SCDC) interaction trigger signal to a consumer electronics control (CEC) device in response to the CEC device being connected to the display device via the HDMI extension interface; the second switching circuit does not comprise the transmitting pin and the receiving pin;
at least one processor, connected to the display, the HDMI extension interface, the HDMI native interface and the switching circuit, and configured to execute computer instructions to enable the display device to:
in response to the CEC device being connected to the display device via the HDMI extension interface, identify a first interface number of the HDMI extension interface connected to the CEC device, and receive SCDC interaction information fed back by the CEC device, wherein the SCDC interaction information is information fed back by the CEC device according to the SCDC interaction trigger signal;
send the first interface number to the second switching circuit to enable the second switching circuit to switch a communication link between the at least one processor and the HDMI extension interface corresponding to the first interface number; and
in response to the CEC device determining that the display device supports an SCDC function based on the SCDC interaction information, perform SCDC interaction with the CEC device based on the communication link directly connected.

2. The display device according to claim 1, wherein before the CEC device is connected to the display device via the HDMI extension interface, the transmitting pin is used to pull up a system on chip (SOC) Hotplug pin by maintaining a 5V pull-up state; wherein the receiving pin configured to send the SCDC interaction trigger signal to the CEC device is configured to:
before the CEC device is connected to the display device via the HDMI extension interface, receive an SOC Hotplug pull-up signal sent by the at least one processor;
when the CEC device is connected to the display device via the HDMI extension interface, receive a device 5V pull-up signal sent by the CEC device; and
send the SCDC interaction trigger signal to the CEC device according to the SOC Hotplug pull-up signal and the device 5V pull-up signal.

3. The display device according to claim 1, wherein the at least one processor configured to execute computer instructions to enable the display device to identify the first interface number of the HDMI extension interface connected to the CEC device is configured to:
acquire a first physical address of the CEC device connected to the display device; and
search the first interface number matching the first physical address based on a pre-stored mapping relationship, wherein the pre-stored mapping relationship comprises a correspondence between physical addresses and interface numbers of the HDMI extension interfaces.

4. The display device according to claim 1, wherein the at least one processor comprises an SOC and a register;
wherein the register is configured to receive the SCDC interaction information written by the CEC device in response to the CEC device being connected to the display device via the HDMI extension interface;
the SOC is configured to read the SCDC interaction information from the register;
wherein the at least one processor configured to execute computer instructions to enable the second switching circuit to switch the communication link between the at least one processor and the HDMI extension interface corresponding to the first interface number, is configured to:
switch a serial clock (SCL) line of the SOC to an SCL line of the HDMI extension interface corresponding to the first interface number, and
switch a serial data (SDA) line of the SOC to an SDA line of the HDMI extension interface corresponding to the first interface number.

5. The display device according to claim 4, wherein the SCDC interaction information at least comprises an SCDC interaction request; and the at least one processor is configured to execute computer instructions to enable the display device to:
before performing SCDC interaction with the CEC device based on the communication link, write feedback information into the register according to the SCDC interaction request, to enable the CEC device to read the feedback information from the register, and to perform SCDC interaction with the display device based on the feedback information;
wherein the feedback information indicates that the display device supports the SCDC function.

6. The display device according to claim 5, wherein the at least one processor configured to execute computer instructions to enable the display device to perform SCDC interaction with the CEC device based on the communication link directly connected, is configured to:
in response to the CEC device inputting an audio and video signal to the display device via the first switching circuit, detect a signal state of the audio and video signal; and
write the signal state of the audio and video signal into the register, to enable the CEC device to read the signal state of the audio and video signal from the register, and to determine whether the SCDC interaction is abnormal according to the signal state of the audio and video signal.

7. The display device according to claim 6, wherein the at least one processor is configured to execute computer instructions to enable the display device to:
in response to the SCDC interaction being abnormal, stop receiving the audio and video signal from the CEC device;
in response to the signal state being a no data state and/or a signal unstable state, determine that the SCDC interaction is abnormal.

8. The display device according to claim 1, wherein the at least one processor is configured to execute computer instructions to enable the display device to:
based on detecting an external device connected to a device interface, set extended display identification data of the display device as initial extended display identification data, to enable the external device to parse the extended display identification data of the display device; wherein the device interface is the HDMI extension interface and/or the HDMI native interface;
receive an information frame sent by the external device, parse the information frame to obtain information frame parsing data; wherein the information frame is used to represent a parsing result of the extended display identification data in response to the external device not parsing the extended display identification data normally;
update the initial extended display identification data according to the information frame parsing data; and
send a parsing instruction of the extended display identification data to the external device, to enable the external device to re-parse the extended display identification data of the display device;
wherein the at least one processor configured to execute computer instructions to enable the display device to update the initial extended display identification data according to the information frame parsing data is configured to:
acquire a total number of bytes of the initial extended display identification data and a first number; wherein the first number represents a number of bytes capable of being read in response to the external device parsing the extended display identification data;
in response to the first number being an integer multiple of a number of field bytes, send the total number of bytes to the external device, to enable the external device to re-parse the initial extended display identification data according to the total number of bytes; and
in response to the first number being not an integer multiple of the number of field bytes, control the display to display first prompt information; wherein the first prompt information is used to prompt a user to reconnect the external device.

9. The display device according to claim 8, wherein the at least one processor is configured to execute computer instructions to enable the display device to:
in response to the first number being equal to a preset value, execute the step of sending the parsing instruction of the extended display identification data to the external device; in response to detecting that the number of bytes capable of being read by the external device is equal to the preset value, control the display to display the first prompt information;
in response to the first number being not equal to the preset value, execute a step of acquiring a first byte number of the initial extended display identification data.

10. The display device according to claim 8, wherein the at least one processor is configured to execute computer instructions to enable the display device to:
in response to the first number being the same as a first byte number, acquire first unidentified information; wherein the first unidentified information represents an unidentified data block obtained by the external device parsing the extended display identification data; and acquire a data block type of the unidentified data block;
in response to the data block type being a preset type, update the extended display identification data of the display device to first extended display identification data; wherein a protocol version number of the first extended display identification data is lower than a protocol version number of the initial extended display identification data;
in response to the data block type being not a preset type, delete the unidentified data block from the initial extended display identification data, to update the initial extended display identification data.

11. The display device according to claim 10, wherein the at least one processor is configured to execute computer instructions to enable the display device to:
in response to no unidentified data block being detected, acquire second unidentified information; wherein the second unidentified information is used to represent an unidentified byte;
in response to the unidentified byte being a video parameter, acquire a replacement parameter based on a preset video parameter database, and update the unidentified byte in the initial extended display identification data to the replacement parameter;
in response to the unidentified byte being an audio parameter, in response to the audio parameter being an audio format, delete the unidentified byte from the initial extended display identification data, and in response to the audio parameter being not the audio format, update the unidentified byte in the initial extended display identification data to an audio replacement parameter; wherein a capability value of the audio replacement parameter is lower than a capability value of the audio parameter;
in response to the unidentified byte being not the video parameter or the audio parameter, delete the unidentified byte from the initial extended display identification data;
wherein the at least one processor is configured to execute computer instructions to enable the display device to:
in response to no unidentified byte being detected, acquire a number of bytes of an unidentified segment and third unidentified information; wherein the third unidentified information represents the unidentified segment, and the unidentified segment comprises a plurality of consecutive bytes;
in response to the number of bytes being an integer multiple of the number of field bytes, switch the extended display identification data of the display device;
in response to the number of bytes being not an integer multiple of the number of field bytes, acquire a target data block corresponding to a first byte of the unidentified segment, and delete a byte representing a display device function from the target data block.

12. The display device according to claim 11, wherein the at least one processor is further configured to execute computer instructions to enable the display device to:
in response to no unidentified segment being detected, acquire standard configuration information of the display device and fourth unidentified information; wherein the fourth unidentified information represents unidentified configuration information, and the configuration information comprises function information and parameter information;
update the unidentified configuration information in the initial extended display identification data according to the standard configuration information;
wherein the at least one processor is further configured to execute computer instructions to enable the display device to:
in response to no unidentified configuration information being detected, acquire abnormal check bit information;
acquire an abnormal field according to the abnormal check bit information;
calculate a target check bit of the abnormal field, and update an abnormal check bit in the initial extended display identification data to the target check bit;
send the parsing instruction of the extended display identification data to the external device.

13. The display device according to claim 8, wherein the at least one processor is configured to execute computer instructions to enable the display device to:
in response to a media resource signal sent by the external device while parsing the extended display identification data normally, parse the media resource signal to obtain media resource data;
control the display to display the media resource data.

14. The display device according to claim 8, wherein the at least one processor is configured to execute computer instructions to enable the display device to:
obtain external device connection statuses of at least two device interfaces;
based on detecting a target external device connected to a target device interface, detect a device type of the target external device;
in response to the device type indicating a power amplifier device, acquire a connection mode between the target external device and the target device interface;
in response to the connection mode being cascade, switch a video playback channel of the display device to the target device interface to enable the display to display video data sent by the target external device;
in response to the connection mode being non-cascade, not switch the video playback channel of the display device.

15. The display device according to claim 14, wherein the at least one processor configured to execute computer instructions to enable the display device to detect the device type of the target external device is configured to:
send a connection information acquisition request to the target external device via the target device interface, to enable the target external device to feed back connection information according to the connection information acquisition request, wherein the connection information comprises a logical address of the target external device;
receive the connection information fed back by the target external device, and parse the logical address from the connection information;
acquire the device type of the target external device based on the logical address.

16. The display device according to claim 14, wherein the at least one processor configured to execute computer instructions to enable the display device to detect the device type of the target external device is configured to:
acquire a target logical address of the power amplifier device;
send a power amplifier device response instruction carrying the target logical address to the target external device; wherein the power amplifier device response instruction is used to enable the target external device to feedback reply information in response to a logical address of the target external device being the target logical address;
in response to the reply information sent by the target external device, mark the device type of the target external device as the power amplifier device.

17. The display device according to claim 14, wherein the at least one processor is configured to execute computer instructions to enable the display device to:
in response to the device type indicating the power amplifier device, acquire function information supported by the target device interface;
in response to the target device interface supporting an audio return channel function, execute the step of acquiring the connection mode between the target external device and the target device interface;
in response to the target device interface not supporting the audio return channel function, control the display to display target prompt information, wherein the target prompt information is used to prompt a user to switch a device interface connected to the target external device;
wherein the at least one processor is configured to execute computer instructions to enable the display device to:
in response to the target device interface supporting the audio return channel function, acquire a first physical address of the target device interface;
send a physical address acquisition instruction to the target external device via the target device interface, to enable the target external device to feed back a second physical address according to the physical address acquisition instruction;
receive the second physical address sent by the target external device;
in response to the first physical address being the same as the second physical address, execute the step of acquiring the connection mode between the target external device and the target device interface;
in response to the first physical address being different from the second physical address, control the display to display second prompt information; wherein the second prompt information is used to prompt a user to change the target external device connected to the target device interface.

18. The display device according to claim 14, wherein the at least one processor is configured to execute computer instructions to enable the display device to:
in response to the device type not indicating the power amplifier device, acquire a device status of the target external device;
in response to the target external device being in a powered-on state, switch the video playback channel of the display device to the target device interface;
in response to the target external device being in a standby state, not switch the video playback channel of the display device;
wherein the at least one processor configured to execute computer instructions to enable the display device to acquire the device status of the target external device is configured to:
detect a voltage signal of the target device interface;
in response to the voltage signal carrying a transition signal, mark the target external device to be in the powered-on state;
in response to the voltage signal not carrying the transition signal, mark the target external device to be in the standby state.

19. The display device according to claim 14, further comprising:
an audio output interface configured to connect an audio player, wherein the audio player is used to play audio data;
wherein the at least one processor is configured to execute computer instructions to enable the display device to:
after acquiring the connection mode between the target external device and the target device interface, in response to the connection mode being cascade, set the audio playback channel of the display device to the audio output interface to enable the audio player to play the audio data of the display device;
in response to the connection mode being non-cascade, set the audio playback channel of the display device as the target device interface, to enable the target external device to play the audio data of the display device;
wherein the at least one processor configured to execute computer instructions to enable the display device to acquire the connection mode between the target external device and the target device interface is configured to:
send an audio return channel initialization instruction to the target external device;
in response to no initialization success information fed back by the target external device being received, mark the connection mode as cascade;
in response to the initialization success information fed back by the target external device being received, the connection mode is marked as non-cascade.

20. A device control method, comprising:
in response to a consumer electronics control (CEC) device being connected to a display device via an high definition multimedia interface (HDMI) extension interface, identifying a first interface number of the HDMI extension interface connected to the CEC device, and receiving Status and Control data channel (SCDC) interaction information fed back by the CEC device;
wherein the display device comprises at least two HDMI extension interfaces, and the HDMI extension interface is in communication connection with an HDMI native interface via a switching circuit; the switching circuit comprises a first switching circuit and a second switching circuit; the first switching circuit comprises a transmitting pin and a receiving pin, and the receiving pin is configured to send an SCDC interaction trigger signal to the CEC device in response to the CEC device being connected to the display device via the HDMI extension interface; the second switching circuit does not comprise the transmitting pin and the receiving pin; the SCDC interaction information is information fed back by the CEC device according to the SCDC interaction trigger signal;
sending the first interface number to the second switching circuit to enable the second switching circuit to switch a communication link between at least one processor of the display device and the HDMI extension interface corresponding to the first interface number via the second switching circuit; and
in response to the CEC device determining that the display device supports an SCDC function based on the SCDC interaction information, performing SCDC interaction with the CEC device based on the communication link directly connected.
